(19) United States
(12) Patent Application Publication
(10) Pub. No.: US 2026/0116790 A1
(43) Pub. Date: Apr. 30, 2026

(54) APPARATUS, SYSTEM AND METHODS FOR WATER PURIFICATION WITH ZERO LIQUID DISCHARGE AND RESOURCE RECOVERY

(71) Applicant: OXbyEL Technologies, Inc., Phoenix, AZ (US)

(72) Inventors: Colleen LEGZDINS, West Vancouver (CA); Preston MONTALVO, Peoria, AZ (US)

(73) Assignee: OXbyEL Technologies, Inc., Phoenix, AZ (US)

(21) Appl. No.: 18/929,806

(22) Filed: Oct. 29, 2024

(51) Int. Cl. C02F 1/467; C02F 1/32; C02F 1/44; C02F 1/52; C02F 101/16

(52) U.S. Cl. CPC C02F 1/4672; C02F 1/32; C02F 1/444; C02F 1/4676; C02F 1/52; C02F 2101/16; C02F 2303/04

(57) ABSTRACT

The invention of the current application is directed to a water purification system, A water retentate treatment module, and a water treatment method. The water retentate treatment module includes an electrolytic treatment unit and a dissolved solids recovery unit. A water retentate stream is received in a electrolytic treatment unit which performs at least one process selected from the group consisting of electrochemical oxidation, hardness removal and reduction, and/or the water retentate stream is received in a dissolved solids removal unit wherein at least one of hydrogen, ammonia, or hydrogen peroxide are recovered.

### BACKGROUND

The widespread contamination of wastewater, recycled water, surface water and groundwater sources by emerging contaminants, microplastics, and nanomaterials is a global concern. Conventional wastewater and drinking water treatment processes are less or not effective due to their low concentrations and diverse chemical properties. Conventional wastewater treatment plants are unable to efficiently remove per-and polyfluoroalkyl substances and other hazardous micropollutants from wastewater discharged to drinking water sources.

Emerging contaminants that pollute drinking water sources include pharmaceuticals, pesticides, fertilizers, heavy metals, natural and synthetic hormones, personal care products (such as fragrances and cosmetics), food additives, dyes, industrial chemicals such as bromated flame retardants and phthalate ester, microplastics and nanoparticles and nanomaterials. Those contaminants that have received increased regulatory attention include pharmaceuticals, personal care products, 1,4-Dioxane, per-and polyfluoroalkyl substances (PFAS), microplastics, disinfection byproducts, and certain industrial chemicals such as persistent organic pollutants including dioxins, furans, PCBs, PAHs, pesticides, herbicides, chlorinated solvents, and semi volatiles organic compounds. Generally, most emerging contaminants are present with co-occurring contaminants so complex and expensive treatment systems are required.

The presence of micropollutants in drinking water is a significant concern because even at low concentrations, they have adverse effects on human health. Identified health effects include endocrine disruption, carcinogenicity, reproductive effects, and antibiotic resistance. Nanomaterials such as nanoplastics are a concern due to their ability to cross the blood-brain barrier increasing the incidence of neurodegenerative diseases like Alzheimer's disease.

In addition to micropollutants, drinking water systems struggle to remove health-based contaminants like disinfection byproducts (DBPs), lead, nitrate, arsenic, radionuclides, and microbial contaminants. For example, in 2018, 27% of public water systems in the US (40,533 systems) reported at least one drinking water standard violation [EPA Summary and Evaluation of PWS Compliance in Calendar Year 2018, Enforcement and Compliance History Online or ECHO Drinking Water Dashboard]. In 2022, the number of violations increased with 43.2% of the US community water systems violating at least one drinking water standard [National Enforcement and Compliance Initiative: Increasing Compliance with Drinking Water Standards at Community Water Systems|US EPA]. In addition, the deterioration of water distribution systems contributes to heavy metal, microbial and asbestos contamination.

To protect human health and the environment, new water and wastewater remediation techniques that are inexpensive, effective, simple, practical, and environmentally friendly are required to eliminate emerging contaminants. The decrease in freshwater supplies and increasing environmental regulatory requirements, particularly for micropollutants, on wastewater discharges is also impacting industrial processes globally. Industrial processes generate large volumes of wastewater, with up to 40% disposed of without treatment.

A new approach is required due to the increased costs of handling and disposing of toxic wastewater and limited supplies of freshwater. By providing low-cost water purification methods and systems that provide clean water suitable for recycling, re-use and/or safe recharge of freshwater sources, and nonhazardous solid residues suitable for recovering valuable resources and safe disposal.

Zero Liquid Discharge (ZLD) and minimal liquid discharge (MLD) water treatment aim to minimize liquid waste discharge by maximizing water recovery and leaving behind only solid waste. Traditional ZLD treatment is a multi-stage process that starts with various pre-treatment technologies, continues with membrane filtration, and ends with evaporators and crystallizers.

Evaporators and crystallizers are expensive, energy intensive, transfer hazardous contaminants to the solid waste, and in the case of PFAS, transfer PFAS to the evaporator and crystallizer vapor or distillate. For many wastewaters, heavy metal salts, organics, calcium and ammonium chlorides are not easy to crystallize, and expensive pretreatment processes are required which makes the process impractical. A new ZLD/MLD water purification approach that is inexpensive, reduces energy consumption, recovers valuable resources and does not generate hazardous solid or liquid waste is therefore desirable.

### SUMMARY OF THE INVENTION

The current application is directed to a modular water purification apparatus, system and methods for effective and sustainable water purification of contaminated water including groundwater, surface water, stormwater, wastewater and brine. The treatment system and methods described herein remove and/or destroy contaminants that include emerging contaminants including, for example, 66 chemicals listed in USEPA contaminant candidate list CCL 5, micropollutants, microplastics, nanomaterials and standard drinking water contaminants such as nitrates, metals and dissolved solids. The water purification system provides minimal and/or zero liquid discharge, resource recovery of chemical feedstocks from removed minerals and metals, conversion of nitrate contamination to ammonia chemical feedstock, hydrogen peroxide for re-use, and/or hydrogen for reduced carbon emission energy conversion.

The water purification system comprises one or more optional treatment modules and generally up to 4 modules. The 4 modules include may include, for example, a preliminary treatment module, a filtration module, a disinfection module, and a filtration retentate treatment module. Each module may have one or more optional treatment steps to address different contaminants that may be present in the contaminated water. The filtration retentate treatment module can include optional treatment units, for example, an electrolytic treatment unit and a dissolved solids recovery unit, each with one or more optional treatment and resource recovery steps.

Contaminated water or wastewater is optionally fed to the preliminary treatment module. The preliminary treatment module may include one or more of a solids/sediment filtration step, a chemical oxidation step, UV radiation step, lime softening step, coagulation and flocculation step and/or low-pressure filtration step. The preliminary treatment steps are conducted sequentially in a series of chambers or basins in a single vessel to reduce the process footprint. The low-pressure filtration step is integrated with flocculation to eliminate clarification steps, reduce the process footprint, improve process efficiency and reduce cost. When a treatment step is not required, its chamber or basin can be removed, and the vessel's size can be reduced accordingly.

The type of contaminants in the water and background water quality determines whether any feed water preliminary treatments are required. For example, if there is iron, manganese, heavy metals, and/or metallic organic compounds in the contaminated water, the water passes through a chemical oxidation step. If there is silica or phosphorous in the contaminated water, the water passes through a coagulation step. The contaminated water may also be fed directly to the low-pressure filter after passing through a sediment/particulate filter if oxidation and/or coagulation are not required.

An optional free oil removal step such as dissolved air flotation or filtration may be used first to remove free oil from oily wastewater. The removed oil can be recovered for re-use.

Following oil removal, the total suspended solids (TSS) of the contaminated water can be measured. If present, the water is optionally fed through a liquid-solid filter or other solids removal device such as a centrifugal separator. Automatic backwash filters can be used to lower costs and maintain continuous operation. Dewatering and optionally solid washing is carried out to provide for safe solids disposal. The recovered water from dewatering and washing can be recycled back to the contaminated feed water for treatment.

Depending on the type and concentration of contaminants, the contaminated water may be directed to a chemical oxidation step. An oxidant and by-product oxygen recovered from the electrolytic treatment unit are injected into the contaminated water and reacted with the contaminants in an oxidation vessel or chamber. Suitable oxidants include, for example, free chlorine, permanganate, hydrogen peroxide, ozone, persulfate, and other oxidants known to those in the art.

A preferred oxidant for use herein is ozone since it has a high oxidation potential and efficacy, small footprint, does not add any chemicals to the water and rapid reaction time. In addition, ozone mineralizes many organics such as pesticides, all BTEX hydrocarbons (Benzene, Toluene, Ethylbenzene, Xylene), oxidizes dissolved metals such as iron and manganese, removes colors, tastes, and odors, de-complexes bound heavy metals, destroys inorganic components such as sulfides, cyanides, and nitrites, disinfects by killing bacteria and inactivating viruses. The ozone reactions are very rapid and contact time is short. Ozone is also used as a front-end step to remove bromide by forming bromate for subsequent removal by coagulation with low pressure filtration and/or nanofiltration. Similarly, pre-oxidation of Arsenic(III) to Arsenic(V) by ozone improves arsenic removal by coagulation, flocculation, low pressure filtration, nanofiltration and/or reverse osmosis.

Ozone also acts as a flocculant to aid in filtration of metals from water eliminating the need to add flocculant chemicals. The ozone oxidizes and flocculates metals such as iron and manganese, lead, copper, arsenic, zinc, and cadmium for subsequent filtration. Ozone is also beneficial as it removes biofilm from water lines, pumps, storage tanks, and it is the best way to provide super saturated dissolved oxygen in water for irrigation.

Catalytic ozonation uses catalysts to enhance the decomposition of ozone leading to the production of hydroxyl radicals for advanced chemical oxidation. Solid catalyst particles mainly used in practice are manganese oxides and iron oxides. Catalytic ozonation is facilitated by the simultaneous oxidation of metals such as iron and manganese typically found in contaminated waters, so no other oxidants or catalysts are needed. Other transition metal ions (e.g. Fe²⁺, Cu²⁺, Cr²⁺, Mn²⁺, Ni²⁺, Co²⁺, Cd²⁺, Ag⁺, Zn²⁺) already present in contaminated water and wastewater may also act as a catalyst to produce free radical oxidants.

Following chemical oxidation, if the contaminated water contains residual ozone, it is directed through a UV chamber to eliminate the remaining ozone. If the contaminated water does not require chemical oxidation but contains free chlorine, it can be directed through a UV chamber to dechlorinate. Free chlorine is corrosive to filtration membranes and is required to be removed in advance of membrane filtration. Alternatively, the chlorine can be neutralized with sodium bisulfite, sodium sulfite, sodium metabisulfites, hydrogen peroxide, sodium adsorbate, and/or ascorbic acid dosing. Alternatively, the water may be passed through a granular activated carbon bed and/or exposed to UV radiation to neutralize the free chlorine. UV radiation is preferred in this invention as it does not add any chemicals to the water.

If the contaminated water does not require chemical oxidation but contains microbial contamination, it can be directed through a UV chamber for disinfection. Microbial fouling of filtration membranes is problematic and eliminating the microbes is desirable.

If the contaminated water requires removal of dissolved contaminants, the contaminated water can be fed to a coagulation-flocculation step followed by low pressure filtration or fed directly to low pressure filtration. The coagulation-flocculation step combines contaminants including precipitates, colloidal contaminants, silica, phosphorous, arsenic, and dissolved matter such as organics into aggregates for solids removal by filtration.

Coagulation-flocculation contaminant removal can also be carried out in tanks using a mechanical mixer and clarifier, in a single vessel using a solids contact clarifier, in a dual chamber tank with coagulation in the first chamber and flocculation with submerged filtration in the second chamber, and/or in-line coagulation in a static mixer followed by low pressure filtration.

To perform coagulation, the pH of the water which governs the coagulation behavior of both contaminants and coagulant is measured before addition of the coagulant. To optimize performance, pH adjustment can be made to the water by injecting either acid or base upstream of the coagulant and mixing provided by in-line static mixers. The pH required is determined by the type of coagulant used.

Many different coagulants are available for coagulation. These include, for example: inorganic coagulants based on aluminum (Al) and iron (Fe) such as sodium aluminate, ferric sulfate, ferric chloride, aluminum sulfate (alum), and magnesium chloride; mineral salt based such as polyferric chloride, polyferric sulfate, polyaluminum chloride (PAC), polyaluminum sulfate and polyferric aluminum chloride; synthetic coagulants such as polyamines and polyacrylamides; polydiallydimethylammonium chlordide (PolyDADMAC), Polethylene Oxide (PEO); natural coagulants such as guar gum, gum arabic, potato starch, chitosan and xanthan gum; and organic polymers and other coagulants based on metals other than Al and Fe such as titanium and zirconium.

Selection of the appropriate coagulant is dependent on the background water quality; target pollutants being removed, and the requirement for removing both the target contaminants and coagulant residuals. The preferred coagulants include sodium aluminate and sodium aluminate in combination with alum. It is alkaline rather than acidic and produces less solid waste. The alkalinity provides improved rejection by reverse osmosis membranes of numerous contaminants such as boron and negates the need to pH adjust the water.

Sodium aluminate is also a source of aluminum hydroxide which is an effective adsorbent and coagulant for many industrial pollutants, particularly silica. The resulting aluminosilicate precipitates formed can further sorb and remove inorganic and organic compounds, particularly heavy metals. Aluminum hydroxide from sodium aluminate is also effective for the removal of bromate.

Sodium aluminate is also preferred for the removal and recovery of phosphorus. It is 60% more efficient than ferric chloride. Sodium aluminate provides a concentrated source of aluminum in an alkaline media thereby eliminating the need for additional alkalinity. Sodium aluminate provides nearly the same amount of alkalinity as 25% caustic soda and substantially more aluminum than other aluminum-based coagulants reducing the amount of chemical required to precipitate phosphorus compared to ferric chloride and PAC. This results in lower treatment cost, replacement of two chemicals with one, and reduced sludge generation. Alternatively, for contaminated waters with very high hardness and total dissolved solids (TDS), calcium oxide and/or calcium hydroxide, i.e., lime and hydrated lime, may be added with the sodium aluminate to remove or reduce TDS. Particularly for reverse osmosis filtration, high salinity results in high osmotic pressure and high operating pressure reaching a limit where RO is no longer feasible. The sodium aluminate and optionally calcium dose concentration are dependent on the water concentration of hardness and TDS and the desired fraction of removal.

Following coagulation, flocculation to increase the size of aggregates is preferably combined with low-pressure filtration in a single compartment. A flocculation basin is divided into a main settling chamber and a submerged filtration unit. Optionally, the filtration unit may be in a unit separated from the flocculation basin.

To remove the aggregates, low pressure filtration is preferred over traditional methods such as clarification, sedimentation, flotation and/or deep-bed filtration that require large tanks and costly chemical separation aids such as flocculants. The filter may include microfiltration and/or ultrafiltration membranes. Ultrafiltration is preferred.

Low pressure filtration includes the advantages of not requiring chemicals, has a relatively low energy consumption, has a simple and automated operation, and has a high pollutant removal efficacy. Microfiltration and ultrafiltration are low pressure filtration methods that remove contaminants by size exclusion and/or particle capture. A preferred low pressure filtration method is ultrafiltration.

Ultrafiltration is a low pressure-driven membrane separation process defined by the molecular weight cut-off (MWCO) of the membrane used. Generally ranging from a few thousand to about 1 million daltons (10³-10⁶ Da). The porous membrane removes silt, turbidity, macromolecules, soluble polymers, microplastics, silica, colloids, particulates, fats, bacteria, proteins, nanoparticles, oil, endotoxin bacteria, viruses, organics, alkyl phthalates, natural organic matter, some micropollutants such as pesticides and aggregates formed by coagulation. The pore size is small and can range from 0.01-0.1 μm. A practical and preferred range of ultrafiltration pore size is 0.02-0.05 μm.

The ultrafiltration membranes may be hollow fiber and/or flat plate and configured into a cassette that fits into the flocculation basin and is submerged. For contaminated water that does not require chemical oxidation and/or coagulation, such as surface and ground water, direct filtration may be conducted. However, it is advised to run the water first through the UV chamber for disinfection to prevent fouling of the membrane surface. The submerged membrane elements are kept clean by continuously air scouring using a blower with oxygen from the electrolytic treatment unit. The water permeates the filter by a pressure difference with suction pumping that produces a small vacuum. The filtered solids are dewatered, washed if required, and recovered for reuse or safe disposal. The recovered water is recycled to the flocculation basin.

An alternative step to sodium aluminate coagulation and aggregation is electrocoagulation. Electrocoagulation is only practical for contaminated waters with significant electrical conductivity such as industrial wastewater, leachate, stormwater, mining discharge, brine and seawater. Drinking water sources, such as groundwater and surface water, have too low a conductivity therefore requires the addition of a supporting electrolyte such as a base, acid or salt. A minimal amount of total dissolved solids with a conductivity equal to or greater than 1000 mg/L sodium chloride or preferably greater than 10 g/L is required to provide adequate conductivity for energy efficiency and cost-effectiveness.

Electrocoagulation is favorable because the process combines oxidation, oil removal, coagulation and flocculation, disinfection and hardness removal steps. It reduces the number of steps required in the preliminary treatment module. The main disadvantage is that the electrodes are consumed and need frequent replacement. Suitable electrode materials include, for example, iron, iron alloys, aluminum and aluminum alloys.

The preliminary treatment module with electrocoagulation consists of a solids/sediment filtration step, electrocoagulation and flocculation steps, and a low-pressure filtration step. The preliminary treatment steps are conducted sequentially in a series of chambers or basins in a single vessel to reduce the process footprint. Electrocoagulation is conducted in a chamber with an array of sacrificial anode-cathode pairs. A preferred electrode configuration is iron - aluminum electrode pairs. Combined with pH control, an alternating current, or periodic current reversal is applied to slowly dissolve one or more electrodes to provide in-situ aluminum and/or iron coagulant. A high current that provides voltage greater than the oxidation-reduction potentials of contaminants and/or free-chlorine evolution may be used to provide contaminant oxidation and water disinfection.

One or more optional amendments may be added to the electrocoagulation chamber. To improve the water conductivity, one or more salts, acid, and/or base may be added. To improve oxidation, one or more oxidants such as ozone and hydrogen peroxide may be added. To improve coagulation, one or more chemical coagulants such as aluminum hydroxide, PAC and/or sodium aluminate may be added.

For high chloride water, if the electrocoagulation anode voltage is equivalent or greater than the chlorine evolution potential, free chlorine may be generated. To protect the filtration membranes, the free chlorine is neutralized. Amendments that neutralize free chlorine include ascorbic acid, sodium adsorbate, sulfites, bisulfites, metabisulfites, and hydrogen peroxide. These may be added to the coagulated water as it enters the flocculation chamber or alternatively, added to the electrocoagulation chamber during the electrocoagulation step. Alternatively, the coagulated water may pass through a UV radiation chamber and/or a granular activated carbon bed after electrocoagulation to neutralize the free chlorine.

The coagulated water enters the flocculation basin where the aggregates and precipitated solids settle. The sludge is directed to a dewatering unit and the recovered water is returned to the flocculation basin. The dried solids are directed to the solids handling depot for storage, reuse and/or disposal.

The low-pressure filtration step is preferably ultrafiltration which may be integrated with flocculation in the same basin to reduce the process footprint and improve process efficiency. Alternatively, a separate flocculation basin may be used followed by an optional chlorine neutralization step and separate ultrafiltration unit.

The treated water exits the preliminary treatment module and depending upon the remaining contaminants requiring treatment, it is generally directed to the filtration module, but it may be directed to the disinfection module, exit the treatment system and/or be directed to the retentate treatment module for contaminant oxidation, contaminant reduction and/or dissolved solids removal and recovery.

The water directed from the preliminary treatment module to the filtration module is collected in a small retention tank. The purpose of the retention tank is to provide water for backwashing the filter elements, receive recycled and treated retentate, and for forward-flow of the pre-treated water to the filtration module.

The retention tank water quality is measured using in-line sensors to evaluate the scaling and fouling potential of the water. The concentration of fouling metals, total organic carbon (TOC), alkalinity, hardness, and dissolved solids contaminating the treated water may be measured. Mineral scales are the most common and these form when the dissolved substances in the feed water exceed their solubility limit and precipitate out of solution and adhere to the membrane. The most common scales are calcium carbonate, calcium sulfate, barium sulfate, strontium sulfate and silica. Calcium phosphate and calcium fluoride scale are possible but less common. Foulants that adhere to the membrane surface include metal oxides & metal hydroxides (e.g. Fe, Mn, Cu, Ni, Zn, Al), colloidal fouling (organic and/or inorganic complexes e.g. iron, aluminum, silica, sulfur, or organic matter), polymerized silica (dissolved silica), biological fouling (e.g. bacterial slimes, algae, fungi, molds), and organic fouling (e.g. dissolved natural organic matter). Particular attention is given to the major foulants that result in membrane failure. These are bio foulants, metal oxide precipitates (Fe, Mn, Al), clay/alumino-silicate precipitates, calcium carbonate, and silica.

The successful removal and reduction in suspended solids, metal oxides, metal hydroxides, colloidal particles, silica, biological matter, organic substances, and TDS in the preliminary treatment module during pre-oxidation, coagulation, and low-pressure filtration effectively eliminates or significantly reduces the scaling and/or fouling potential of the water. The high-quality water achieved after one or more preliminary treatment steps minimizes membrane cleaning which maintains permeability, prolongs the life of the high-pressure membranes, and reduces treatment cost and complexity.

If the fouling and scaling constituents of the water are partially or not removed, and the SDI is equal to 3 and less than or equal to 5, then high-pressure filtration is feasible with continuous cleaning and membrane filter backwashing. This adds complexity and treatment cost therefore an SDI less than 3 is preferred. If the water hardness is greater than 150 mg/L, ion exchange softening to reduce hardness may be used, and the water is passed through an automated ion exchange filter. The filter backwash is directed to solids dewatering where the solids are recovered, and the recovered water is recycled back to the retention tank.

If scaling salts in the feed water will oversaturate the membrane retentate, antiscalant dosing with or without acid addition is preferred because of cost and ease of operation. The amount of and type of antiscalant injected is site dependent and depends not only on water analysis but also flow rate, temperature, pH, system recovery rate, membrane type, and how the membranes are arranged. The range of antiscalant dosing is typically from 1 to 6 mg/L. Antiscalant formulations include phosphonates, polyacrylates, carboxylates, polyphosphates, organophosphates, phosphonates, acrylic acid homopolymers, sulfonic acids, polymaleic acid and copolymers. The most common antiscalants are phosphonates and the organic polymers poly acrylic acid (PAA), polymethacrylic acid (PMAA), and poly maleic acid (PMA).

The filtration element(s) are comprised of high-pressure nanofiltration (NF), reverse osmosis (RO) and/or forward osmosis (FO) membranes. Membrane filtration is simple to operate, generates few waste products, does not require chemical additives, and has superior contaminant removal efficacy. NF and RO are efficient for eliminating a wide range of contaminants, particularly those not removed by conventional methods such as micropollutants and per-and polyfluoralkyl substances (PFAS), and is a preferred treatment for arsenic, asbestos, and cancer-causing radionuclides. Other contaminants removed by nanofiltration and reverse osmosis include suspended solids, hardness, multivalent ions, heavy metals, salts, nitrate, fluoride, iron and manganese, ammonia, bacteria, sulfate, viruses, cysts, and organic compounds such as pharmaceuticals, color, disinfection byproducts, trihalomethane (THM) precursors, oil, and the majority of target pollutants for drinking water treatment. The wide range of contaminants removed reduces treatment cost by replacing many different treatment methods with one filtration step.

The membrane filter elements in this invention are composed of one or more reverse osmosis, low-pressure reverse osmosis, nanofiltration, hybrid nanofiltration/reverse osmosis and/or forward osmosis-nanofiltration membranes. The filter elements may be spiral wound, hollow fiber, tubular and/or plate and frame, and are generally configured in crossflow mode and crossflow mode with reverse flow but may be configured in dead-end mode. Spiral wound membranes are preferred because they are less susceptible to fouling versus hollow fiber membranes. The membrane materials may consist of one or more polyether sulfone (PES), cellulose acetate (CA), polyacrylonitrile (PAN), polyamide (PA), and polyethyleneimine (PEI). In addition, different techniques used to modify membranes namely: grafting, blending, coating, and embedding functionalized nanoparticles may be applied to the membranes.

Nanofiltration membranes have a lower rejection of monovalent ions versus reverse osmosis but higher water flux and lower operating pressure. Nanofiltration is preferred versus reverse osmosis for contaminant removal from drinking water, wastewater, and other contaminated water sources. It has higher permeate fluxes, lower operating pressure and energy consumption, lower capital cost, lower operating and maintenance costs, small footprint, ease of automation, flexibility to adapt different feed water quality, and wide-spectrum removal of various water contaminants to ensure high product water quality.

For some emerging contaminants and micropollutants with low molecular weights, reverse osmosis has a higher removal efficacy than nanofiltration and is a preferred filter element. Generally, NF membranes possess an effective pore size around 0.5-2 nm with a corresponding molecular weight cut-off (MWCO) ranging from 200 to 1000 Da. Reverse osmosis membranes have an effective pore size ranging from 0.1-1 nm and a MWCO of less than 100 Da. For many emerging contaminants, they have molecular weights greater than 200 Da. NF and RO membranes with a MWCO varying between 200 and 400 Da are suitable for their removal from water. Nanofiltration and reverse osmosis membranes are also effective for the removal of per-and polyfluoroalkyl substances (PFAS). NF and RO membranes with a MWCO between 100 and 300 Da are suitable for PFAS removal. Depending on the target water quality in the permeate, one or more reverse osmosis membrane elements may be combined with nanofiltration elements having higher MWCO values to save on capital and operating costs while still meeting the target contaminant level in the purified water.

The feed water leaves the filtration module retention tank and preferably flows in a single pass through one or more filter elements mounted in membrane housings. The logistics of feeding the contaminated water through the membrane housings depend on their configuration. The filter elements may be reverse osmosis, nanofiltration or a combination of both. The filter retentate may pass through one or more filter elements in one or more stages. Some or all retentate from one or more filter elements or stages may be recirculated through one or more filter elements or stages. Some or all retentate may be directed to the retentate treatment module and/or recirculated to the filtration module retention tank.

A preferred method is to recycle the retentate to the retention tank after passing through the filtration element(s). Once the retentate's dissolved solids concentration and/or the concentration of fouling and/or scaling contaminants become too high and reduces the permeation rate, the retentate from one or more filter elements is then directed to the retentate treatment module. Treated retentate exiting retentate treatment module may be recycled to the feed water of one or more filter elements in one or more stages. Preferably, the treated retentate is directed to the retention tank. The increased flow velocity of the feed water with recycled treated retentate and/or reverse flow prevents membrane scaling and fouling to increase permeate recovery and reduce membrane cleaning.

The fouling and scaling saturation point of the filter retentate for each filter element in one or more stages is calculated using a process model with the water quality data obtained from the retention tank sensors. Combined with flow rate, transmembrane pressure, velocity, and membrane filter recoveries, the recycling of retentate to one or more filter elements or stages is mass transfer computer controlled using a process model and machine learning.

The permeate, a.k.a. purified water, exits the filter elements and is collected in a permeate storage or retention tank. The purified water in the retention tank is used for clean-in-place membrane filter cleaning and feed for the disinfection module or exits the water purification system.

The purified water is fed to the disinfection module if advanced oxidation, disinfection and/or plumbosolvency treatment is required. For direct potable re-use applications and if the dissolved organics in the contaminated water are poorly rejected by high pressure filtration, an advanced oxidation polish is performed to destroy these contaminants.

Reverse osmosis and nanofiltration do not remove or have low removal for some micropollutants of concern. These include solvents such as trichloroethylene (TCE), phenols, some volatile organic compounds such as benzene, toluene, xylene (BTEX), emerging contaminants such as 1,4 Dioxane, carcinogenic chemicals such as N-nitrosodimethylamine (NDMA), other N-nitrosamines, and toxic pesticides such as metaldehyde, atrazine, herbicides, algal toxins, and chromophoric dissolved organic matters whose molecules are smaller than water. Chemicals that are strongly hydrophobic and/or highly polar are also poorly rejected by nanofiltration membranes.

Advanced oxidation processes produce highly reactive radicals, primarily hydroxyl radicals, in situ to destroy the micropollutants not removed by RO and/or NF. Pollutants destroyed by advanced oxidation hydroxyl radicals include nitrosodimethylamine (NDMA), 1,4-dioxane, 2-methylisoborneol (MIB), geosmin, caffeine, tricolorethylene (TCE), perchloroethene (PCE), trinitrotoluene (TNT), odor compounds, herbicides (e.g. atrazine), pesticides, volatile organic compounds, halogenated compounds (e.g. 1,1-dichloropropene, 1-chloropenetane, 1,2-dichloroethane), aromatics, nitrogen containing organics, carboxylic acids, phenol, sulfur containing organics, chlorinated alkenes, ketones, alcohols, ammonia, hydrogen sulfide, atrazine, carbofuran, alachlor, endrin, chloroethene (vinyl chloride), tetrachloroethene, benzene, toluene, 0-Xylene, MTBE, chloroform, PCBs, and polyaromatic hydrocarbons.

Chemical advanced oxidation methods include combining ozone with UV radiation, hydrogen peroxide with UV radiation, hydrogen peroxide with iron salt (Fenton's), ozone with hydrogen peroxide, adding chlorine and ozone with UV radiation, TiO₂, boron nitride or other photocatalyst particles with UV radiation, and other methods known in the art.

The commercially proven methods are combining ozone and/or hydrogen peroxide with UV radiation. Ozone combined with UV is preferred in this invention because it is used in the preliminary module and reduces complexity and cost. The UV radiation step may also be used for disinfection. It does not add any chemicals to the water and has a small footprint.

If the purified water requires advanced oxidation, ozone or alternatively hydrogen peroxide or both are injected into the water feed and mixed with an inline static mixer. The water then passes through the UV chamber where advanced oxidation is performed. If the purified water does not require advanced oxidation but requires disinfection, it is only directed through the UV chamber.

If the purified water requires residual disinfection, one or more disinfectants are dosed into the water and mixed using an inline static mixer. Preferred residual disinfectant chemicals are chlorine and chloramine but others may be used. If the purified water requires remineralization, the water is passed through a remineralization filter containing one or more water soluble calcium and magnesium minerals, preferably recovered from the electrolyte softener.

If the purified water requires plumbosolvency treatment due to copper and/or lead pipes in the distribution network, the pH, alkalinity and hardness of the purified water are measured. For soft water, less than 50 mg/L as calcium carbonate, the pH is adjusted to 8-8.5 through injection of an acid or base from the cleaning skid chemicals. Additional dosing with orthophosphate is optionally performed depending on the alkalinity of the water. The chemical additions are mixed in the water with an in-line static mixer. The purified water then exits the water purification system.

The filtration module filter retentate that is not immediately recirculated to the retention tank, is fed to the retentate treatment module. The module consists of two treatment units, an electrolytic treatment unit and a dissolved solids recovery unit. The electrolytic treatment unit performs anodic electrocatalytic oxidation, cathodic electrocatalytic reduction and/or hardness removal. Electrolytic treatment is a sustainable and safe method that does not require chemical reactants, is relatively insensitive to influent water quality and does not produce secondary waste.

Electrochemical oxidation of water and wastewater contaminants is a safe, simple, reliable and flexible method for the mineralization of a diverse range of water and wastewater pollutants that are recalcitrant and/or toxic to conventional biological and chemical treatments. The oxidation process eliminates refractory pollutants and disinfects wastewater in a single treatment by hydroxyl radical oxidation and/or direct electron transfer at high anodic voltages. The reduction process reduces oxidized contaminants to safe end-products and/or valuable materials by direct and/or indirect electron transfer at high cathodic voltages.

The electrolytic oxidation process is effective in destroying persistent organic pollutants, and most US priority pollutants and EU priority list compounds. Specifically, electrochemical oxidation is proven to mineralize PFAS, BOD, COD, TOC, metals, endocrine and other biological disruptors, pesticides including chlorinated hydrocarbons, organo-phosphates, and carbamates, herbicides, dioxins, PCBs, active pharmaceutical ingredients and solvents, PCP and antibiotics, pathogens and microorganisms, ammonical-N, amines, nitrogen compounds and ammonia, proteins, hydrocarbons, haloalkanes & alkenes, solvents, alcohols, phenols and chlorinated phenols, aliphatic and aromatic organics, chlorinated phenols and PCBs, polyaromatic hydrocarbons (PAHs), AOX, Benzene, Toluene, Ethyl benzene and Xylene (BTEX), semi-volatile and volatile organic compounds (VOCs), humic substances, high molecular weight compounds, dyes, pigments and colorants, cyanide, hydrogen sulfide, formate, glycols, amines, sulfurous mercaptans, amines, sulfides, organic acids and other organic compounds.

The electrochemical reduction process is effective in reducing oxidized contaminants to safe end-products through direct and indirect electron transfer. These pollutants include oxyanions, halogenated compounds (e.g. trichloroethylene), nitrogenous compounds (e.g. nitrosamines), nitrate, nitrite, perchlorate, bromate, chlorate and chlorite, hypochlorous acid and hypochlorite. Any electrochemical oxidation by-product such as free-chlorine is also reduced to safe end-products by electrolytic reduction.

The electrolytic treatment unit comprises one or more oxidation, oxidation-softening and/or reduction stacks. An electrolytic treatment stack is comprised of one or more divided unit cells in one or more arrays. The membrane cell dividers are proton ion selective membranes, porous battery separators, and/or cation exchange membranes. One or more arrays are configured into oxidation stacks, oxidation-softening stacks, and/or reduction stacks. The preferred electrolytic treatment unit comprises one or more oxidation-softening stacks, followed by one or more oxidation stacks, and ending with one or more reduction stacks. Depending on the type of contaminants in the retentate, the retentate is fed only to the applicable stack(s) for treatment and may be recirculated through one or more stacks or unit cell arrays.

If the contaminated retentate entering the electrolytic treatment unit contains hardness ions and/or cations and organic and/or inorganic pollutants, it first passes through the anode compartment(s) of one or more oxidation-softening stack(s). If the retentate exiting the oxidation-softening stack(s) contains contaminants requiring further oxidation, the retentate may be subsequently directed through the anode compartment(s) of one or more oxidation stack(s).

If the contaminated retentate entering the electrolytic treatment unit does not contain hardness ions and/or cations, but contains inorganic and organic contaminants, it is directed through the anode compartment(s) of one or more oxidation stack(s).

If the contaminated retentate entering the electrolytic treatment unit only contains oxidized contaminants, the retentate passes through the cathode compartment(s) of one or more reduction stack(s).

For contaminated retentate with hardness, organics, inorganics and oxidized contaminants, the retentate may be directed first through one or more anode compartments of oxidation-softening stacks, next through one or more anode compartments of oxidation stacks, and finally through one or more cathode compartments of reduction stacks. The treated retentate then exits the electrolytic unit and is directed to either the dissolved solids recovery unit or to the filtration module retention tank.

In the oxidation-softening stack(s), anodic oxidation and/or mineralization of the contaminants is conducted on the anode catalyst surface and the dissolved hardness ions are ionically transported through the separator dividing the unit cell(s) into the cathode compartment and the electrolyte. The cathode half-cell reaction is hydrogen evolution, and the electrolyte is recirculated through the cathode compartments to pick up the hardness ions, through a softener which removes the hardness ions, and back to the electrolyte reservoir contained in the electrolyte skid.

If the mineralization or decomposition potential of the contaminants is less than 3 volts, the anodic voltage is operated at 3 volts or less and oxidation and/or mineralization is provided by direct electron transfer and/or indirect oxidation by reaction with by-product oxygen, chlorine or other lower potential oxidants. For recalcitrant organics, the anodic voltage is operated at 3 volts (V_{NHE}) and hydroxyl radical generating anode catalysts are used to provide oxidation by both direct electron transfer and reaction with hydroxyl radicals.

If the retentate contains contaminants with redox potentials greater than 3 V_{NHE} such as per- and polyfluoroalkyl substances, the anodic voltage of the oxidation-softening unit cells is operated at greater than 3 V_{NHE}, preferably greater than 4.5 V_{NHE} or higher to exceed the oxidation potential of the contaminants. A stable, high voltage anode catalyst that provides direct electron transfer oxidation is used with or without a hydroxyl radical generating catalyst.

The treated retentate is analyzed for chemical oxidant demand (COD) and/or PFAS compounds and concentration after exiting the oxidation-softening stacks to determine the anode voltage required by the oxidation stacks and/or if more than one pass through the stacks is required. The retentate is passed through one or more anode compartments of one or more oxidation stacks. The cathode half-reaction is generally hydrogen evolution, and the electrolyte is recirculated through the cathode compartment(s) of the stacks from the electrolyte reservoir. The half-reaction may alternatively be the generation of water and/or hydrogen peroxide. Air or oxygen is fed to the cathode where the oxygen is reduced to water and/or hydrogen peroxide. The hydrogen peroxide is collected for off-take or re-use as an oxidant.

The anodic voltage of the oxidation stack(s) is operated at a voltage greater or equal to the redox potential of the contaminant(s). If the mineralization or decomposition potential of the contaminants is less than or equal to 3 V_{NHE}, the anodic voltage is operated at 3 V_{NHE} and hydroxyl radical generating anode catalysts are used to increase the rate of destruction and reduce the electrode area. If the retentate contains contaminants with redox potential greater than 3 volts such as per-and polyfluoroalkyl substances, the anodic voltage is operated at greater than 3 V_{NHE}, preferrable greater than 4.5 V_{NHE} or higher to exceed the oxidation potential of the contaminants. A stable, high voltage anode catalyst that provides direct electron transfer oxidation is used with or without a hydroxyl radical generating catalyst.

The retentate is fed to the cathode compartments of the reduction stack(s) where oxidized contaminants are reduced to safe end-products by direct electron transfer or indirect reduction by hydrogen. The cathode voltage is operated at a value equal to or exceeding the reduction potential of the contaminants for direct electron transfer reduction and/or for the generation of hydrogen as a reducing agent. The generation of solvated electrons may be conducted at a cathodic voltage equal to or more negative than −2.8 V_{NHE}. The anode half-cell reaction is oxygen evolution, and the electrolyte is recirculated through the anode compartment(s) back to the electrolyte reservoir.

For retentate with nitrate concentrations greater than 10 ppm, the nitrate may be selectively reduced to ammonia. Recovering ammonia for use as a feedstock for fertilizers, chemicals, pharmaceuticals, polymers and/or fuel is preferred since the cathodic reduction reaction has a better NH₃-yield efficiency and lower energy consumption than nitrogen reduction and the traditional Haber-Bosch process.

To reduce nitrate selectively to ammonia, transition metal catalysts, their alloys and oxides have shown high activity and selectivity with close to 100% faradaic efficiency. Suitable materials include copper, cobalt, nickel, iron and their alloys and mixed oxides, borides and other high hydrogen overpotential catalysts such as transition metals. Suitable 3-dimensional substrates decorated with catalyst particles include glassy carbon, titanium, steel, tin, copper, lead and niobium. Alloying the transition metal catalysts with corrosion resistant metals such as niobium and tantalum can also improve durability. To improve efficiency, catalysts with high overpotentials for hydrogen evolution are preferred.

Before entering the reduction stacks'cathode compartments, the pH of the retentate with nitrates is measured, and if necessary, the retentate pH is adjusted to less than or equal to 6 to produce soluble ammonium (NH₄ ⁺) ion rather than volatile ammonia (NH₃). The cathode voltage is operated at a value equal to or exceeding the reduction potential of the nitrate to ammonia reaction, preferably ≥0.7V_{NHE}, for direct electron transfer reduction. The electrolyte is recirculated through the anode compartment of the reduction stacks back to the electrolyte reservoir. The anode half-cell reaction is oxygen evolution, and the oxygen is separated from the electrolyte and directed to the preliminary treatment module or vented.

The treated retentate with ammonium ions exits the cathode compartments and is directed to a diafiltration step. The ammonium is concentrated using a nanofiltration membrane such as NF90 or a reverse osmosis membrane. The concentrated ammonia solution is directed to a tank for storage and off-take use. The permeated retentate is nitrate-free and exits the electrolytic treatment unit and is directed to either the dissolved solids recovery unit or the filtration module retention tank.

A single electrolyte solution is recirculated through all anode and cathode compartments in all stacks. The electrolyte is both catholyte for the oxidation cell arrays and anolyte for the reduction cell arrays. An electrolyte skid contains an electrolyte reservoir with temperature and conductivity senors, a dosing pump for acid and/or base to control conductivity and a heat exchanger to control temperature of the electrolyte solution. The unit cells are functional with low conductivity electrolyte but maintaining a conductivity equal to or greater than 50 μS/cm is preferred.

The hardness and other cations in the catholyte exiting the oxidation-softening stack(s) is directed through an ion exchanger to purify the electrolyte and remove them for recovery before reaching the electrolyte reservoir. A preferred ion exchange resin is a strong acid cation (SAC) exchanger suitable for acidic solutions. The SAC resins are regenerated with either a sodium salt solution or with an acid (H⁺) such as sulfuric or hydrochloric acid. The preferred regenerant is acid obtained from the membrane cleaning skid. The softener backwash is directed to the preliminary treatment module.

The oxygen gas generated from the anode half-cell reactions may be preferably directed to the preliminary treatment module to aid in the oxidation step, scour submerged low pressure membrane elements and/or is vented to air. The hydrogen gas generated from the cathode half-cell reactions is collected and directed for energy recovery applications. The hydrogen may be directed to a compressor and gas cylinder storage unit for off-take sales as a carbon-free fuel.

Alternatively, the hydrogen may be directed to a natural gas blending unit where up to 20 volume percent of hydrogen is permitted in many regions to lower carbon emissions. The hydrogen may optionally be directed to an industrial hydrogen steam boiler or a hydrogen hot water boiler. Hydrogen can comprise 100% of the input fuel or be combined with other readily available fuels to lower carbon emissions and reduce the cost of the combustion process.

The hydrogen may alternatively be directed to a recombiner boiler and/or a hydrogen autocatalytic recombiner to recover water and heat, or the hydrogen may be directed to on-site hydrogen storage and fuel cell to provide a source of backup power or electricity to lower the water purification energy consumption.

The passive hydrogen autocatalytic recombiner removes by-product hydrogen by the catalytic recombination of hydrogen with air using catalysts such as platinum and/or palladium and does not need an external power supply or any control. The exothermic reaction of hydrogen and oxygen produces water, and the air-water mixture is exhausted by natural convection. The water is recovered and recycled back to the filtration module retention tank. The catalyst element consists of a stable, high temperature substrate such as stainless steel, alumina, ceramic or other suitable material that has been coated with the catalyst. The removal rate of hydrogen is dependent on the surface area of catalyst, volume % of hydrogen in air at the inlet, inlet gas pressure and temperature and gas velocity. At low concentrations of hydrogen, the recombination takes place on the catalyst surface. At high concentrations of hydrogen, recombination may take place at both the catalyst surface and in the gas phase volume of the recombiner.

To provide on-site intermittent and/or back-up power, the hydrogen captured is dried, compressed and stored in one or more gas storage tanks. A fuel cell module of one or more fuel cell stacks is connected to the hydrogen gas feed where hydrogen is combined with air and/or oxygen to produce electricity on demand. Commercial fuel cell power systems will provide 30% or more recovered electricity to the water purification system from the captured hydrogen reducing its energy consumption.

The treated retentate from the electrolytic treatment unit is directed to the filtration module retention tank and/or to the dissolved solids recovery unit. The total dissolved solids of the retentate is measured to determine if when combined with the feed water in the retention tank, one or more dissolved solids are near or at their solubility limit and/or a reduction in the permeation rate, recovery rate and/or quality of the permeate will occur.

The hardness ions are removed by the electrolytic treatment unit so that the treated retentate can be recycled to the filtration unit and only periodically directed to the dissolved solids recovery unit. This concentrates the remaining dissolved solids so that they can be cost-effectively removed and recovered as valuable minerals.

The dissolved solids that are concentrated in the retentate during recycling to the filtration unit and not removed by the electrolytic treatment system are anions, such as chloride, sulfate and fluoride. These anions contribute to decreased water permeability, increased osmotic pressure, and/or fouling and scaling of the filter elements as their concentration increases. Other dissolved solids that are concentrated by retentate recycling, such as silica and phosphate, are also separated and recovered as valuable minerals by the dissolved solids recovery unit.

The dissolved solids recovery unit contains one or more sequential precipitation steps using lime, sodium aluminate, calcium aluminate and/or potassium aluminate, with pH control and/or temperature control, and one or more low pressure filtration steps. To maximize the value of recovered solids, sequential separation and precipitation of discrete valuable minerals is performed. This method is inexpensive, reduces or eliminates solid waste, has low energy consumption and is simple. The reduction in solid waste and off-take sales or re-use of the recovered minerals reduces treatment cost and contributes to the environmental sustainability of the treatment process.

If the retentate water entering the dissolved solids recovery unit contains magnesium and has not been treated by one or more oxidation-softening stacks, an optional lime (CaO) or hydrated lime (Ca(OH)₂), lime-soda ash (Na₂CO₃) or an ion exchange softening step may be conducted first to remove magnesium and optionally calcium. Magnesium interferes with one or more selective precipitation steps therefore its removal is desired. Magnesium is precipitated as magnesium hydroxide with lime at pH=11.5. Alternatively, lime may be added with sodium, calcium and/or potassium aluminate to remove dissolved solids in addition to magnesium.

The precipitation softening step is preferably conducted in a single, solids contactor clarifier but may also be carried out in separate basins incorporating rapid mix, flocculation and liquid-solid separation. A solids contactor unit incorporates the processes of mixing, coagulation, flocculation, liquid/solids separation, automatic precipitate removal and sludge recycle in a single vessel.

In the contact clarifier, water is mixed with lime, soda ash and/or recycled sludge, coagulated and flocculated in the center of the vessel. The solution is then forced down through the precipitated sludge blanket at the bottom of the tank to the outer liquid-solid separation compartment. The clarified water is directed either to sequential separation and precipitation or returned to the filtration module retention tank. The excess sludge is directed to solids dewatering for precipitate recovery and the recovered water is recycled back to the clarifier.

As an alternative to sequential precipitation, a two-stage precipitation step may be performed to separate, remove and recover dissolved solids, particularly for retentate of contaminated water that was not coagulated, clarified and/or filtered in the preliminary treatment module. In the first stage, sodium aluminate and at pH 8.5 is added to the retentate to coagulate and precipitate colloidal contaminants, silica, phosphorous, arsenic, and dissolved matter such as organics into aggregates.

The first stage is preferably conducted in a solids contactor clarifier which combines the functions of chemical treatment, mixing, flocculation, and liquid-solid separation in a single vessel. The influent retentate water is mixed with sodium aluminate, pH adjusting chemicals, recycled precipitates then coagulated and agglomerated in the center well of the vessel. The water then proceeds downward out of the central well, through the sludge blanket of precipitates at the bottom and outward to the clarification zone where precipitates settle. Sludge pumps remove excess precipitates keeping steady state and the clarified water exits through the radial outlets. The first stage clarified retentate is then directed to the second stage contact clarifier. The excess sludge is directed to a dewatering and optionally solids washing step with the recovered water recycled back to the contact clarifier. The dried solids are directed to the solids handling depot for storage, reuse and/or safe disposal.

In the second stage a mixture of lime or hydrated lime, sodium aluminate, and/or calcium aluminate may be added to the clarified retentate at pH 11.5 to remove or reduce TDS by removing chloride, sulfate, lithium and/or fluoride ions as precipitates and/or aggregates. The molar concentrations of aluminum and calcium dosed are dependent on the water concentration of chloride, sulfate, lithium and/or fluoride, and the desired fraction of their removal.

The second stage is also preferably conducted in a solids contactor clarifier which combines the functions of chemical treatment, mixing, flocculation, and liquid-solid separation in a single vessel. The influent retentate water is mixed with sodium aluminate, pH adjusting chemicals, recycled precipitates and/or lime then coagulated and agglomerated in the center well of the vessel. The water then proceeds downward out of the central well, through the sludge blanket of precipitates at the bottom and outward to the clarification zone where precipitates settle. Sludge pumps remove excess precipitates keeping steady state and the clarified water exits through the radial outlets. The clarified retentate is directed either to pH neutralization and low-pressure filtration or the filtration module retention tank. The precipitated solids and aggregates are directed to a dewatering and optionally solids washing step with the recovered water recycled back to the coagulation vessel. The dried solids are directed to the solids handling depot for storage, reuse, off-take sales or safe disposal.

Fluoride may be removed from the retentate water by calcium fluoride (CaF₂) precipitation with calcium chloride and/or selectively removed by cryolite (Na₃AlF₆ and NaAlF₄) precipitation with sodium aluminate at low pH. Cryolite precipitation with sodium aluminate is preferred in this invention. The process produces significantly less sludge volume than calcium fluoride, and the size of precipitates are larger thereby faster and easier to remove. The recovered cryolite is a valuable feedstock extensively used in the aluminum electrolytic industry. The recovered cryolite may also be recovered for off-take sales to produce abrasives, welding agents, soldering agents, blasting, glass, pyrotechnics and metal surface treatments.

To precipitate cryolite, the sodium aluminate is dosed with a fluoride to aluminum molar ratio range of 5-7 at a pH range of 3-8 and temperature less than 50° C. Preferred precipitation conditions include a pH of 6 to 6.8, a temperature of 20° C. to 30° C., and a fluoride to aluminum molar ratio of 6 to 6.8. The precipitation is preferably conducted in a solids contactor clarifier with cryolite sludge recycling to improve precipitation. To maintain a steady state, a portion of the precipitated cryolite sludge/wet solids is discharged and directed to a dewatering and optionally solids washing step with the recovered water recycled back to the contact clarifier. The dried cryolite is directed to the solids handling depot and stored for off-take sales. The clarified retentate water is then directed to either pH neutralization, low-pressure filtration, a subsequent separation and precipitation step, and/or to the filtration module retention tank.

If the retentate water contains silica in addition to fluoride, two additional valuable fluoride materials, sodium fluorosilicate (Na₂SiF₆) and synthetic cryolite (Na₃AlF₆), may be precipitated with sodium aluminate selectively with pH and temperature control. At a low pH equal to or greater than 1, Na₂SiF₆ is precipitated. At a pH greater than 2, Na₃AlF₆ is precipitated. Maximum recovery of the two fluorides is greatest at a temperature greater than 40° C., and preferably at about 50° C.

If the retentate water contains lithium in addition to fluoride, lithium may also be selectively removed from the retentate by lithium cryolite (Li₃AlF₆) precipitation with sodium aluminate with pH and temperature control. Maximum lithium cryolite recovery is greatest at a pH of 4 to 6 and a temperature of 45° C. to 85° C. The recovered lithium cryolite may be used for battery material manufacture and used to produce abrasives, welding and soldering agents.

Sulfate may be removed from the treated retentate by precipitation with lime and/or limestone at a pH range of 10.5 to 12 and a temperature of less than 60° C. forming gypsum (CaSO₄-2H₂O) which can be recovered for off-take sales. The lime is first hydrated forming quicklime (Ca(OH)₂) and then added to the retentate. A portion of the precipitated gypsum is recycled to improve precipitation and reduce solids volume. Due to the high solubility of gypsum, the minimum sulfate concentration of the retentate with lime precipitation is 1500 mg/L SO₄²⁻ at ambient temperature. Since the method is ineffective for reducing the sulfate concentration below 250 mg/L, which is the US EPA minimum contaminant level, an alternative method or second precipitation step may be conducted to reduce the sulfate concentration below 200 mg/L.

A simple, preferred low-cost method of this invention is to reduce sulfate to concentrations below 200 mg/L by precipitation and adsorption with calcium and aluminum ions from a mixture of lime, quicklime, calcium salts, sodium aluminate, calcium aluminate, aluminum salts, and/or aluminum hydroxide. The preferred precipitation step is by the addition of lime with sodium aluminate and/or calcium aluminate to precipitate Ettringite salt.

The recovered Ettringite salt (3CaO·Al₂O₃·3CaSO₄·32H₂O) can be sold as a feedstock chemical for the concrete, firebrick, alumina and zeolite production industries. Alternatively, the Ettringite salt can be converted back into sodium aluminate which may be re-used or sold as a coagulant to the water industry.

To precipitate Ettringite salt, a mixture of lime with sodium aluminate and/or calcium aluminate is added to the retentate to achieve an aluminum to sulfate molar ratio range of 0.75 to 2, a calcium to sulfate ratio of 2 to 4 at a pH range 11-12 and temperature less than 90° C. The preferred precipitation conditions are a pH=11.2-11.6, a temperature of 20-40° C., and aluminum to sulfate molar ratio of 1-1.25 and calcium to sulfate molar ratio of 3-3.5. The precipitation is preferably conducted in a solids contactor clarifier with Ettringite sludge recycling to improve precipitation. To maintain a steady state, a portion of the precipitated Ettringite sludge is discharged and directed to a dewatering and optionally solids washing step with the recovered water recycled back to the contact clarifier. The dried Ettringite is directed to the solids handling depot for storage and off-take sales. The clarified water is then directed to either pH neutralization, low-pressure filtration, a subsequent separation and precipitation step, and/or to the filtration module retention tank.

Chloride may be precipitated as Friedel's salt (Ca₂Al(OH)₆Cl·2H₂O) by reacting with sodium aluminate and/or calcium aluminate and lime or quicklime. It is a low cost and simple method of removing chloride to below 250 mg/L to achieve reuse standards. If the retentate contains both sulfate and a high concentration of chloride, the sulfate precipitant Ettringite inhibits chloride precipitation, and a two-stage precipitation step is used. Sulfate is primarily removed in the first stage as Ettringite, and chloride in the second stage as Friedel's salt. For low concentrations of chloride, Friedel's salt is co-precipitated with Ettringite salt in a single stage.

The recovered Friedel's salt can be sold as a adsorbent for gas adsorption, wastewater purification, ion exchange and catalysis. Friedel's salt is an effective adsorbent for arsenic, selenium and chromium. Friedel's salt can also be converted into poly aluminum chloride (PAC), which is extensively used as a flocculant in water treatment.

To precipitate Friedel's salt, a mixture of lime with sodium aluminate and/or calcium aluminate is added to the retentate to achieve an aluminum to chloride molar ratio range of 2-4, a calcium to aluminum ratio of 2-5 at a pH range 11-12.5 and temperature less than 65° C. The preferred precipitation conditions are a pH=12, a temperature of 25-35° C., and aluminum to chloride molar ratio of 4 and calcium to aluminum molar ratio of 2-2.5. The precipitation is preferably conducted in a solids contactor clarifier with Friedel's sludge recycling to improve precipitation. To maintain a steady state, a portion of the precipitated Friedel's sludge/wet solids is discharged and directed to a dewatering and optionally solids washing step with the recovered water recycled back to the contact clarifier. The dried Friedel's salt is directed to the solids handling depot for storage and off-take sales. The clarified water is then directed to either pH neutralization, low-pressure filtration, a subsequent separation and precipitation step, and/or to the filtration module retention tank.

To precipitate both Ettringite and Friedel's salt in a single stage, a mixture of lime with sodium aluminate and/or calcium aluminate is added to the retentate to achieve a calcium to aluminum molar ratio range of 1-3, an aluminum to chloride+sulfate ratio of 2-4 at a pH range 11-13 and temperature range 25-65° C. The preferred precipitation conditions are a pH=12-12.5, a temperature of 25-35° C., calcium to aluminum molar ratio of 1.5-2 and aluminum to chloride+sulfate molar ratio of 2-2.5. The precipitation is preferably conducted in a solids contactor clarifier with Friedel's and Ettringite sludge recycling to improve precipitation. To maintain a steady state, a portion of the precipitated sludge/wet solids is discharged and directed to a dewatering and optionally solids washing step with the recovered water recycled back to the contact clarifier. The dried precipitates are directed to the solids handling depot for storage, off-take sales and/or safe disposal. The clarified water is then directed to either pH neutralization, low-pressure filtration, a subsequent separation and precipitation step, and/or to the filtration module retention tank.

To precipitate the residual calcium carbonate and aluminum hydroxide following the precipitation and separation steps, the clarified retentate is directed to an inline static mixer where CO₂ gas is mixed into the retentate to decrease and neutralize the pH. The selection of carbon dioxide gas for pH neutralization is preferred over acid since it enhances environmental sustainability by capturing CO₂ and is more cost effective. Following the mixer, the retentate passes through a low-pressure filter, preferably ultrafiltration where the calcium carbonate precipitates, and any residual aluminum hydroxide particles are removed. The filter backwash containing these particles is returned to the solids contactor clarifier and the clarified retentate is then directed to the filtration module retention tank.

A chemical cleaning skid may be included in the treatment system to provide acid, base and cleaning chemicals for periodic cleaning of the filtration elements in the treatment system including the sediment filter(s), low pressure filter(s) and high-pressure filters, acid for regeneration of the electrolytic unit softening resin bed, and acid or base for pH adjustment of precipitation steps in the preliminary treatment module and dissolved solids recovery unit. An acid and base dosing unit provides chemical cleaning, and the resulting wash water is directed to the resource recovery and disposal unit. Additionally, the acid or base chemicals in the cleaning skid may be used to provide pH and/or alkalinity adjustment throughout the water treatment system and its units as well as acid for regenerating the catholyte ion exchange softener.

Some embodiments include a water purification system which includes:
a water retentate treatment module comprising an electrolytic treatment unit and a dissolved solids recovery unit,
wherein a water retentate stream is received in a electrolytic treatment unit which performs at least one process selected from the group consisting of electrochemical oxidation, hardness removal and reduction, and/or
wherein a water retentate stream is received in a dissolved solids removal unit wherein at least one of hydrogen, ammonia, or hydrogen peroxide are recovered.

In some embodiments, the water retentate stream is converted to a electrolytically treated retentate stream in the electrolytic treatment unit and the electrolytically treated retentate stream is transferred to the dissolved solids removal unit from the electrolytic treatment unit.

In some embodiments, the water purification system additionally includes:
a preliminary treatment module which receives a contaminated water feed, and removes suspended solids and precipitates from the contaminated water feed to form a treated water feed which is feed to the water retentate treatment module or to a filtration module which receives and filters the treated water feed and forms a permeate water stream and a water retentate stream wherein the water retentate is supplied to the water retentate treatment module.

In some embodiments, the preliminary treatment module includes:
a chemical precipitation unit,
a total suspended solids sensor, and
a solids recovery unit.

In some embodiments, the chemical precipitation unit includes
an oxidation vessel,
an ultraviolet light chamber,
a coagulation chamber, and
a vessel including an ultrafiltration cassette.

In some embodiments, the water purification system additionally includes a solids recovery unit which receives the suspended solids and precipitates removed in the preliminary treatment module and dewaters the suspended solids and precipitates to form recovered water which is returned to the preliminary treatment module.

In some embodiments, the filtration module is included in the water purification system and the filtration module receives a clarified retentate stream and recovered water from the dissolved solids recovery unit, and produces a permeate stream.

In some embodiments, the water purification system additionally includes a disinfection module which receives the permeate stream from the filtration module and produces purified water.

In some embodiments, the disinfection module includes:
at least one inline static mixer,
a UV chamber suitable for preforming a UV treatment step,
an inline mixer, and
a mineral filter.

In some embodiments, the water purification system additionally includes a recovery and storage unit which receives least one of hydrogen, ammonia, or hydrogen peroxide which are recovered from the electrolytic treatment unit.

In some embodiments, the water purification system additionally includes a solids handling depot which receives dry precipitates from the dissolved solids recovery unit.

Some embodiment are directed to a water retentate treatment module including:
an electrolytic treatment unit and a dissolved solids recovery unit,
wherein the electrolytic treatment unit comprises:
   at least one electrolytic oxidation-softening stack,
   at least one electrolytic oxidation stack, and
   at least one electrolytic reduction stacks; and
wherein the dissolved solids recovery unit comprises:
   a lime or lime-soda ash softening unit,
   a second step is cryolite precipitation unit,
   a Ettringite precipitation unit,
   a Friedel's salt precipitation unit, and
   a filtration unit.

In some embodiments, the water retentate treatment module additionally includes a recovery and storage unit in fluid connection with the oxidation-softening stack.

In some embodiments, the water retentate treatment module additionally includes a preliminary treatment module in fluid connection with the electrolytic treatment unit.

In some embodiments, the preliminary treatment module includes:
an oxidation vessel,
a coagulation chamber, and
a vessel including an ultrafiltration cassette.

In some embodiments, the preliminary treatment module additionally includes an ultraviolet light chamber.

In some embodiments, the water retentate treatment module additionally includes a solids handling depot in fluid connection with the dissolved solids recovery unit.

Some embodiments herein are directed to a water treatment method including:
receiving a retentate feed water stream into a electrolytic treatment unit,
electrolytically treating the retentate feed water stream in the electrolytic treatment unit to provide an electrolytically treated retentate,
receiving the electrolytically treated retentate in a dissolved solids recovery unit,
filtering the electrolytically treated retentate in the dissolved solids recovery unit to provide a clarified retentate stream and a stream comprising precipitated dissolved solids and dry precipitates.

In some embodiments, electrolytically treating the retentate feed water stream in the electrolytic treatment unit comprises at least one process selected from the group consisting of electrochemical oxidation, hardness removal and reduction, and
where filtering in the dissolved solids recovery unit comprises at least one process selected from the group consisting of a lime or lime-soda ash softening step, a cryolite precipitation step, an ettringite precipitation step, and a friedel's salt precipitation step,
where at least one of hydrogen, ammonia, or hydrogen peroxide are recovered.

In some embodiments, the water treatment method additionally includes pretreating a contaminated water to form a retentate feed water stream wherein pretreating comprises at least one process selected from the group consisting of a chemical oxidation step, exposure to ultraviolet light within an ultraviolet light chamber, injection of a coagulant and mixing within a coagulation chamber, and flocculation and settling in a vessel including an ultrafiltration cassette.

### BRIEF DESCRIPTION OF THE DRAWINGS

The features of the disclosure believed to be novel and the elements characteristic of the invention are provided below with specificity in the appended claims. The figures are for illustration and exemplary purposes only and are not drawn to scale. The disclosure itself, however, both as to organization and method of operation, can best be understood by reference to the description which follows, taken in conjunction with the accompanying drawings in which:

FIG. 1 shows the layout of the zero liquid discharge and resource recovery water purification system 100 with preliminary treatment module 200, filtration module 300, retentate treatment module 700 and disinfection module 400 in a preferred configuration.

FIG. 2 shows one embodiment of the preliminary treatment module 200 with a chemical precipitation unit 170.

FIG. 3 shows one embodiment of the preliminary treatment module 200 with an electrocoagulation precipitation unit 38.

FIG. 4 shows one embodiment of the filtration module 300 with 2-stage filtration.

FIG. 5 shows one embodiment of the retentate treatment module 700 with electrolytic treatment unit 500 and dissolved solids recovery unit 600.

FIG. 6 shows one embodiment of the electrolytic treatment unit 500 with sequential electrolytic oxidation-hardness removal, oxidation and reduction steps.

FIG. 7 shows one embodiment of the reduction stage 800 with nitrate reduction and ammonia capture.

FIG. 8 shows one embodiment of the disinfection module 400 with advanced oxidation, residual disinfection, remineralization and plumbosolvency treatment steps.

FIG. 9 shows one example of the dissolved solids recovery unit 600 with sequential precipitation and separation of cryolite, Ettringite and Friedel's salt.

FIG. 10 shows one embodiment of the dissolved solids recovery unit 600 with single step precipitation and separation of Ettringite and Friedel's salt.

FIG. 11 shows one embodiment of the dissolved solids recovery unit 600 with two step gypsum and Ettringite precipitation and separation.

FIG. 12 shows one embodiment of the dissolved solids recovery unit 600 with two stage chemical coagulation, precipitation and separation.

### DETAILED DESCRIPTION OF DRAWINGS

The embodiments in the disclosure herein can comprise, consist of, and consist essentially of the features and/or steps described herein. In addition, the embodiments may include additional or optional components, steps, or limitations which are described herein or which would otherwise be appreciated by one of skill in the art. It is to be understood that all concentrations disclosed herein are by weight percent (wt. %.) based on a total weight of the composition unless otherwise indicated.

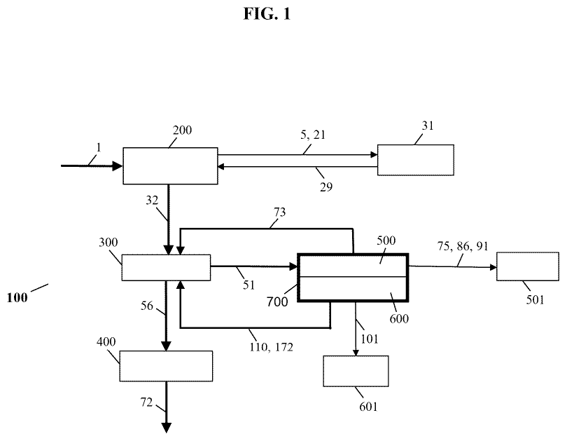

FIG. 1 shows the layout of the zero liquid discharge and resource recovery water purification system 100 with preliminary treatment module 200, filtration module 300, retentate treatment module 700, disinfection module 400 and solids handling depot 601 in a preferred configuration. Contaminated water 1 is fed to the preliminary treatment module 200. One or more treatment steps are performed and following preliminary treatment, the treated water 32 exits the preliminary module and is directed to the filtration module 300. Suspended solids 5 and precipitates 21 removed from the water during one or more preliminary treatment steps are directed to solids recovery unit 31. The recovered water 29 from dewatering the solids is returned to the preliminary treatment module 200.

The treated water 32 is filtered in one or more stages in the filtration module 300. The filtered permeate 56, exits the filtration module 300 and is directed to the disinfection module 400. The rejected water retentate 51, is directed to the retentate treatment module 700. The permeate 56 is treated as required in the disinfection module 400 and exits the treatment system 100 as purified water 72.

The retentate treatment module 700 consists of two treatment units, the electrolytic treatment unit 500 and the dissolved solids recovery unit 600. The retentate 51 is directed to the electrolytic treatment unit 500 for electrochemical oxidation, hardness removal and reduction, and/or the dissolved solids removal unit 600. Recovered hydrogen 75, ammonia 91 and/or hydrogen peroxide 86 are directed to recovery and storage unit 501 for re-use and/or off-take sales.

The electrolytically treated retentate 73, is returned to the filtration module 300 if it does not require removal of dissolved solids. If removal of dissolved solids from the retentate 73 is performed, the dissolved solids are precipitated and dry precipitates 101 are directed to solids handling depot 601 where they are stored for re-use, recycling and/or off-take sales. The clarified retentate 110 exits the dissolved solids recovery unit 600 and is returned to the filtration module 300. The recovered water 172 from solids dewatering in the dissolved solids recovery unit 600 is returned to filtration module 300.

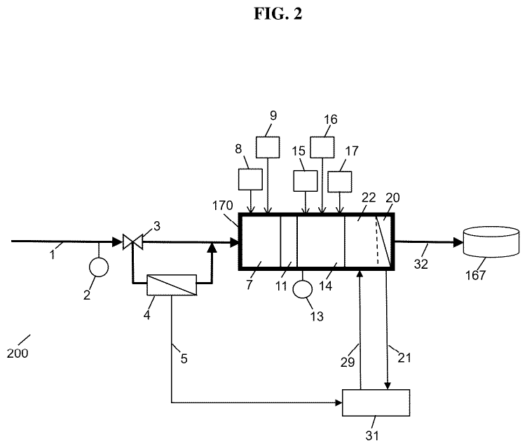

FIG. 2 shows an embodiment of preliminary treatment module 200 with a chemical precipitation unit 170. Contaminated water 1 is fed to the preliminary module 200 where the concentration of total suspended solids (TSS) is first measured by a TSS sensor 2. If no TSS removal is required, valve 3 directs the contaminated water 1 to the chemical precipitation unit 170. If TSS is measured, the contaminated water 1 is directed to a sediment and suspended solids filter 4 by valve 3. Following filtration, the filtered water is directed to the treatment unit 170. The filtered solids are subsequently directed to solids recovery 31. The recovered water 29 from dewatering the solids is returned to the chemical precipitation unit 170.

The chemical precipitation unit 170 consists of optional sequential treatment steps. Contaminated water 1 is first directed to a chemical oxidation step. An oxidant 8, preferably ozone, and oxygen 9 recovered from the electrolytic treatment unit 500 are injected into the water and mixed in an oxidation vessel 7. For greater oxidation efficacy, catalyst particles that enhance the decomposition of ozone to hydroxyl radicals such as transition metals may be contained in the oxidation vessel 7.

Following chemical oxidation, the contaminated water 1 is optionally directed to an ultraviolet light chamber 11 to complete decomposition of the ozone to hydroxyl radicals and/or provide a disinfection step for the contaminated water 1. For removal of dissolved contaminants, the water is directed to a coagulation step. A pH sensor 13 first measures the water pH and the pH is adjusted to 8.5 with a base 15 if required. A coagulant 16, preferably sodium aluminate is injected and rapidly mixed into the water in coagulation chamber 14. For with high hardness and/or dissolved solids, lime 17 may be added with the coagulant to precipitate and remove all or a portion of the hardness and/or dissolved solids.

Following coagulation, the precipitates are flocculated and settled in a subsequent vessel 22 that has a submerged ultrafiltration cassette 20 at the end of the basin for filtering the clarified water. The sludge 21 is recycled to improve separation, and the excess is directed to the solids recovery unit 31. The recovered water 29 from dewatering the solids is returned to the flocculation vessel 22 of the chemical precipitation unit 170. The filtered water 32 exits the preliminary treatment module 200 and is directed to the filtration module retention tank 167.

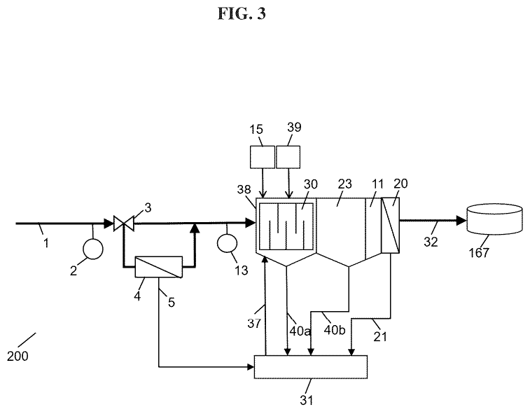

FIG. 3 shows another embodiment of the preliminary treatment module 200 with an electrocoagulation precipitation unit 38. Contaminated water 1 is fed to the preliminary module 200 where the concentration of total suspended solids (TSS) is first measured by a TSS sensor 2. If no TSS removal is required, valve 3 directs the contaminated water 1 to the electrocoagulation unit 38. If TSS is measured, the contaminated water 1 is directed to a sediment and suspended solids filter 4 by valve 3. Following filtration, the filtered water is directed to the electrocoagulation unit 38. The filtered solids are subsequently directed to solids recovery 31. The recovered water 37 from dewatering the solids is returned to the chemical electrocoagulation unit 38.

The electrocoagulation unit 38 includes a tank or vessel divided into compartments to minimize footprint. An electrocoagulation chamber 30 is the first compartment, followed by a flocculation basin 23 with flocculation and solids settling, then an optional UV chamber 11 and finally a low-pressure filter 20.

Contaminated water 1 is directed through an electrocoagulation chamber 30, which includes an array of sacrificial anode-cathode monopolar electrode pairs, preferably iron-aluminum pairs, in the electrocoagulation chamber. A reversing applied voltage is provided by a power supply, not shown, causing the corrosion/passivation of the electrodes and the in-situ formation of iron hydroxides and aluminum hydroxides which provide coagulation and precipitation.

The pH of the water in electrocoagulation chamber 30 is measured by a pH sensor 13 and the pH of the contaminated water is adjusted and controlled by the addition of an acid, base or both 15 to maintain a pH range of 5-7.

One or more chemical agents 39 may be added to the electrocoagulation chamber to improve treatment. To improve coagulation and/or flocculation, one or more chemical coagulants may be added including sodium aluminate, aluminum sulfate, aluminum hydroxide, ferrous sulfate, ferric chloride and/or PAC. To improve the conductivity of the water to lower energy consumption, one or more salts, aid and/or based may be added. To improve oxidation, and provide for advanced oxidation, one or more oxidants such as ozone and hydrogen peroxide may be added.

Upon leaving the electrocoagulation chamber 30, contaminated water 1 is directed to the flocculation and settling basin 23 to clarify the water. The precipitated sludge 40a removed from the electrocoagulation chamber 30 and the precipitated sludge 40b from the flocculation basin 23 are directed to the solids recovery unit 31. The recovered water 37 from dewatering is returned to the electrocoagulation chamber 30.

Contaminated water 1 leaves the flocculation basin 23 and is optionally directed through a ultraviolet light chamber 11 where secondary flocculation, disinfection, decomposition of ozone, generation of hydroxyl radicals and/or chlorine neutralization is performed. Following UV treatment, the clarified water is directed to a basin with a submerged ultrafiltration cassette 20 or a separated ultrafilter. Filter backwash 21 is directed to solids recovery unit 31 and the recovered water 37 is returned to the coagulation chamber 30. Following filtration, the filtered water 32 exits the preliminary treatment module 200 and is directed to the filtration module retention tank 167.

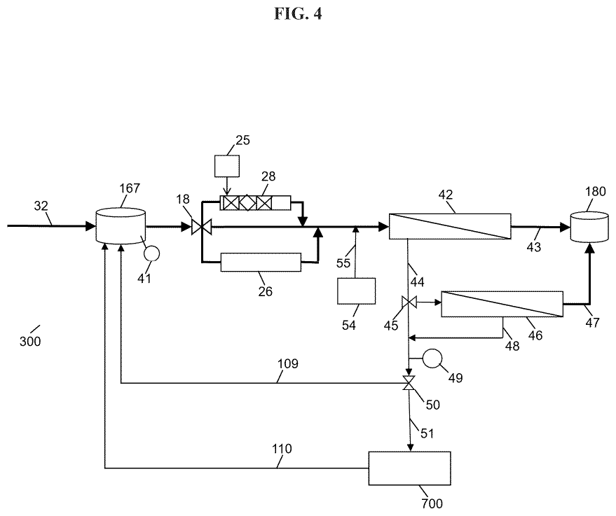

FIG. 4 shows an embodiment of the filtration module 300 with 2-stage filtration. The treated water 32 from the preliminary treatment module 200 is directed to the retention tank 167. The retention tank 167 provides water for forward-flow to high pressure filtration and receives recycled retentate 109 and treated retentate 110 from the retentate treatment module 700. The water quality is measured using a set of sensors 41 to provide parameters that determine fouling and scaling potential of the water.

The water leaves the retention tank 167 and depending on the fouling and scaling potential, it is directed to an inline static mixer 28 for antiscalant 25 dosing, to a resin softening unit 26, and/or to the filtration elements 42 by valve 18. If the hardness is less than 100 mg/L and scaling salts will oversaturate the membrane retentate, the water is directed to antiscalant dosing. The range of antiscalant addition is typically 1-6 mg/L depending on the scaling indices. If the silt density index is greater than 5, the water is directed to ion exchange softening 26. If the silt density index is less than 3, the water is directed to the filtration elements 42. Membrane cleaning skid 54 provides cleaning solutions 55 to the membrane elements when the filter permeation rate decreases.

The feed water flows in a single pass through one or more filter elements 42. The filter elements 42 are composed of one or more nanofiltration, reverse osmosis and/or forward osmosis membranes. Clean permeate 43 is then directed to a permeate storage tank 180. The filter retentate 44 is directed to a second stage of filtration elements 46 by valve 45, recycled and returned to the retention tank 167 by valve 50, or directed to the retentate treatment module 700 by valves 45 and 50 depending on saturation and fouling indices.

Stage one retentate 44 is directed to the second stage filtration elements 46. The second stage permeate 47 flows to the permeate storage tank 180 and the second stage retentate 48 is combined with the first stage retentate 44. The combined retentate water quality is measured using in-line sensors 49 and the combined retentate 109 is directed to the retention tank 167 by valve 50. The combined retentate 51 is directed to the retentate treatment module 700 if its silt density index is equal or greater than 5. The treated retentate 110 leaves the retentate treatment module 700 and is returned to the retention tank 167.

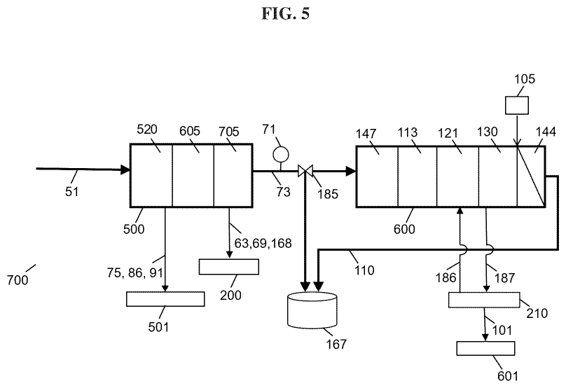

FIG. 5 shows an embodiment of the retentate treatment module 700 with electrolytic treatment unit 500 and dissolved solids recovery unit 600. The combined retentate 51 is fed to the electrolytic treatment unit 500. To oxidize the contaminants and remove hardness, the retentate 51 flows through the first stage of the unit consisting of one or more electrolytic oxidation-softening stacks 520. The stage one treated retentate next flows through the second stage of the unit consisting of one or more electrolytic oxidation stacks 605 to conduct additional oxidation of contaminants.

Following second stage oxidation, the retentate flows through the third stage of the unit consisting of one or more electrolytic reduction stacks 705. Cathode by-products hydrogen 75, ammonia 91 and/or hydrogen peroxide 86 are directed to recovery and storage unit 501 for re-use or off-take sales. Anode by-product oxygen 63, 69, 168 are directed to the preliminary treatment module 200.

The electrolytically treated retentate 73 exits the electrolytic treatment unit 500 and some or all is directed either to the dissolved solids recovery unit 600 or returned to the filtration module retention tank 167 by valve 185 depending on the composition and concentration of the TDS measured by sensors 71.

The dissolved solids recovery unit 600 is composed of four optional sequential precipitation-separation steps and a filtration step to remove and recover valuable minerals for re-use, recycling and/or off-take sales. The first step consists of lime or lime-soda ash softening 147, the second step is cryolite precipitation 113, the third step is Ettringite precipitation 121, and the fourth step is Friedel's salt precipitation 130. The clarified retentate after precipitation-separation has an alkaline pH therefore CO₂ 105 is injected into the retentate to neutralize the pH and precipitate residual calcium carbonate and aluminum hydroxide that are removed by low-pressure filtration 144. Clarified retentate 110 exits the dissolved solids recovery unit 600 and is returned to the filtration module retention tank 167.

The excess precipitates and sludge 187 from all the steps in the dissolved solids recovery unit 600 are directed to solids dewatering unit 210. The solids are dewatered and the recovered water 186 is returned to the dissolved solids recovery unit 600. The dried solids and/or precipitates are directed to the solids handling depot 601.

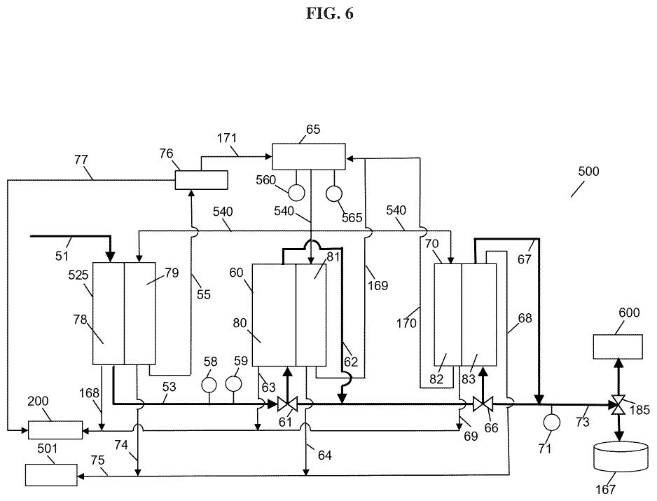

FIG. 6 shows an embodiment of the electrolytic treatment unit 500 with preferred sequential electrolytic steps: oxidation-hardness removal, followed by oxidation and then reduction. The feed retentate 51 is directed to one or more anode compartments 78 of oxidation-softening stack 525. A power supply and its connections, not shown for sake of clarity, provide a voltage to each unit cell in oxidation-softening stack 525 that is equivalent to or greater than the oxidation potential of the target contaminants. The oxidation-softening stack 525 contains one or more anode compartments 78 and one or more cathode compartments 79. The contaminants in the retentate water 51 are oxidized while the retentate 51 passes through one or more anode compartments 78. The hardness and other cations are removed from the retentate water 51 simultaneously by electrolytic migration to one or more cathode compartments 79.

The Electrolyte 540 from the electrolyte skid 65 is directed through one or more cathode compartments 79 of oxidation-softening stack 525 where it receives the hardness cations. The electrolyte with hardness 55 exits cathode compartments 79 of oxidation-softening stack 525 and is directed through a water softener 76 to remove the hardness cations. The preferred ion exchange resin is a strong acid cation exchanger. The softened electrolyte 171 exits the softener and is returned to the electrolyte skid 65. The resins are regenerated preferably with an acid from the membrane cleaning skid 54. The softener backwash 77 is directed to the preliminary treatment module 200.

The electrolytic oxidation potential for contaminant oxidation is high enough that water electrolysis occurs, and oxygen is produced in the anode compartment along with the oxidation products such as carbon dioxide and nitrogen gas. The anode gas mixture 168 is separated from the oxidized retentate water 53 exiting anode compartments 78 of oxidation-softening stack 52 and is directed to the preliminary treatment module 200.

Hydrogen gas 74 evolved in cathode compartments 79 of oxidation-softening stack 52 is separated from the electrolyte 55 exiting oxidation-softening stack 52 and is combined with hydrogen gas mixture 75 that is directed to recovery and storage unit 501 for re-use or off-take sales.

The softened and oxidized retentate water 53 exits oxidation-softening stack 525 and is sampled and analyzed for PFAS by sampling unit 58 and/or for chemical oxygen demand by sampling unit 59. If the contaminant concentrations exceed the target contaminant level, a portion or all the oxidized retentate water 53 is directed to the anode compartments of the oxidation stack 60 by control valve 61. If the contaminant concentrations meet or are below the target contaminant level, oxidized retentate water 53 is directed to valve 66.

Oxidation stack 60 consists of one or more anode compartments 80 and one or more cathode compartments 81. A power supply and its connections, not shown for sake of clarity, provide a voltage to each unit cell in stack 60 that is equal to or greater than the oxidation potential of the remaining contaminants exceeding the target contaminant level. The oxidized retentate water 53 passes through one or more anode compartments 80 in oxidation stack 60 where the contaminants are mineralized. The treated retentate 62 exits oxidation stack 60 and is either combined with oxidized retentate water 53 that bypassed oxidation stack 60 or directed to control valve 66.

Parasitic oxygen from water electrolysis is produced in the anode compartment 80 along with oxidation products such as carbon dioxide and nitrogen gas. The anode gas mixture 63 is separated from the oxidized retentate water 62 exiting the stack 60 and is combined with anode gas 169 and anode gas 69 directed to the preliminary treatment module 200.

Electrolyte 540 from the electrolyte skid 65 is passed through one or more cathode compartments 81 in stack 60. Hydrogen gas generated in cathode compartments 81 is separated from the electrolyte 169 exiting oxidation stack 60 and combined with hydrogen gas mixture 75 and directed to recovery and storage unit 501 for re-use or off-take sales.

If the feed retentate 51 and/or oxidized retentate water 53 contains oxidized contaminants such as nitrate, perchlorate, free chlorine and/or oxyanions at concentration levels greater than the treatment target, the oxidized retentate water 53 is directed by control valve 66 to one or more cathode compartments 83 of the reduction stack 70.

Reduction stack 70 consists of one or more anode compartments 82 and one or more cathode compartments 83. A power supply and its connections, not shown for sake of clarity, provide a voltage to each unit cell in reduction stack 70 that is equal to or greater than the reduction potential of the oxidized contaminants exceeding the target contaminant level.

The oxidized retentate water 53 passes through one or more cathode compartments 83 where electrolytic reduction of the contaminants is achieved. Hydrogen gas 68 generated from water electrolysis is separated from the retentate 67 exiting the reduction stack 70 and is combined with hydrogen gas mixture 75 and directed to recovery and storage unit 501 for re-use or off-take sales.

The total dissolved solids (TDS) of the electrolytically treated retentate 73 is measured by sensor 71 and depending on the TDS value, the treated retentate 73 is directed by control valve 185 to the filtration module retention tank 167 and/or to the dissolved solids recovery unit 600.

The electrolyte skid 65 is composed of an electrolyte reservoir, chemical dosing system and a heat exchanger, which are not shown for clarity. The temperature of the electrolyte reservoir is measured by a electrolyte reservoir temperature sensor 560 and the conductivity is measured by conductivity sensor 565. The heat exchanger provides heating and/or cooling for the electrolyte to maintain its temperature range 0-50° C. and chemical dosing with either a base, acid or salt is used to maintain the electrolyte conductivity equal to or greater than 50 micro-Siemens per centimeter.

Electrolyte 540 leaves the reservoir and is circulated through the cathode compartments 79 of the oxidation-softening stack 525, the cathode compartments 81 of oxidation stack 60, and through the anode compartments 82 of the reduction stack 70 and returned to the electrolyte reservoir in the electrolyte skid 65.

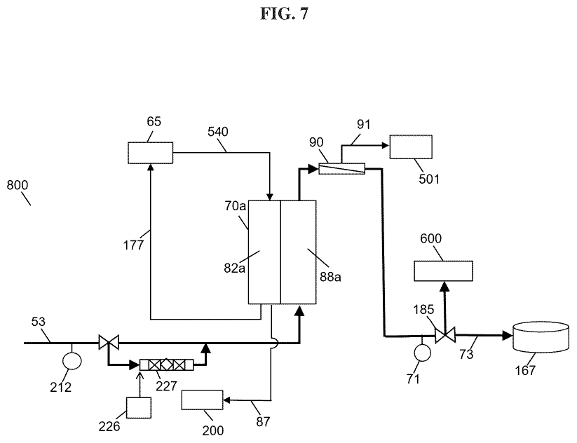

FIG. 7 shows an embodiment of a reduction stage 800 with nitrate reduction and ammonia capture by electrolytic reduction. Reduction stack 70a consists of one or more anode compartments 82a and one or more nitrate reduction cathode compartments 88a. A power supply and its connections, not shown for sake of clarity, provide a voltage to each unit cell in one or more reduction stacks 70a that is equal to or greater than the reduction potential of the nitrate to ammonium reduction reaction. The cathode voltage applied is more negative than or equal to 0.7V_{NHE}.

The pH of the feed oxidized retentate water 53 is measured by sensor 212. If the pH is greater than 6, the pH is adjusted to 6 or below by the addition of acid 226 from the cleaning skid 54 which is mixed into the retentate by an inline static mixer 227. The feed oxidized retentate water 53 is directed through one or more nitrate reduction cathode compartments 88a.

The nitrate contaminants are reduced to ammonium ions and the oxidized retentate water 53 exits the stack and is passed through a diafiltration unit 90 to remove the ammonium from the water and concentrate it by nanofiltration and/or reverse osmosis. The concentrated ammonium 91 is directed to a storage tank 501 for off-take sales or re-use. The permeated retentate 73 leaves the diafiltration unit 90 and its TDS is measured by sensor 71. Depending on the TDS value, the permeated retentate 73 is directed by control valve 185 to the filtration module retention tank 167 or to the dissolved solids recovery unit 600.

Electrolyte 540 leaves the electrolyte skid 65 and is directed through one or more anode compartments 82a of reduction stack 70a. The anode half-cell reaction is oxygen evolution and the product gas 87 is directed to the preliminary treatment module 200. The electrolyte 177 leaving the reduction stack 70a is returned to the electrolyte skid 65.

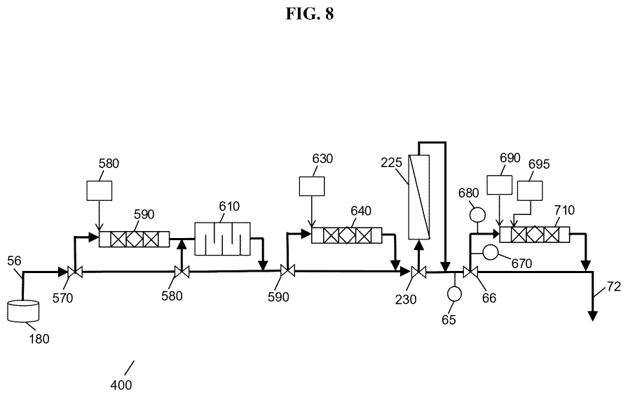

FIG. 8 shows an embodiment of the disinfection module 400 with advanced oxidation, residual disinfection, remineralization and plumbosolvency treatment in a preferred sequence of steps. The feed permeate 56 is directed to the disinfection module 400 from the permeate storage tank 180. If the permeate 56 contains contaminants not removed by the filtration module 300 or the preliminary treatment module 200, the water is directed by first control valve 570 to an advanced oxidation step.

An oxidant 580 such as hydrogen peroxide or preferably ozone, is dosed into the water and mixed by a first inline static mixer 590 followed by UV treatment in the UV chamber 610. If the permeate 56 does not require advanced oxidation, it is directed by first control valve 570 to second control valve 580. If the permeate 56 requires disinfection or ozone neutralization, it is directed by second control valve 580 to the UV chamber 610 and if it does not, it is directed by second control valve 580 to control valve 620.

If the permeate 56 requires residual disinfection for distribution and/or storage, control valve 620 directs the permeate 56 to a second inline mixer 640 where a disinfectant 630 such as chlorine is mixed into the water. If the permeate 56 requires remineralization, control valve 230 directs the permeate 56 through a mineral filter 225 containing water-soluble calcium and magnesium minerals.

If the permeate 56 requires plumbosolvency treatment, the pH is measured by sensor 65, hardness is measured by hardness sensor 670 and alkalinity measured by alkalinity sensor 680. For a hardness less than 50 mg/L as calcium carbonate, the pH is adjusted to 8-8.5 by injection of a base or acid chemical 690 and mixed into the water by third inline static mixer 710. Depending on the alkalinity of the water, orthophosphate 695 is injected and mixed into the water by third inline mixer 710. The resulting purified water 72 exits the disinfection module 400 and water treatment system 100.

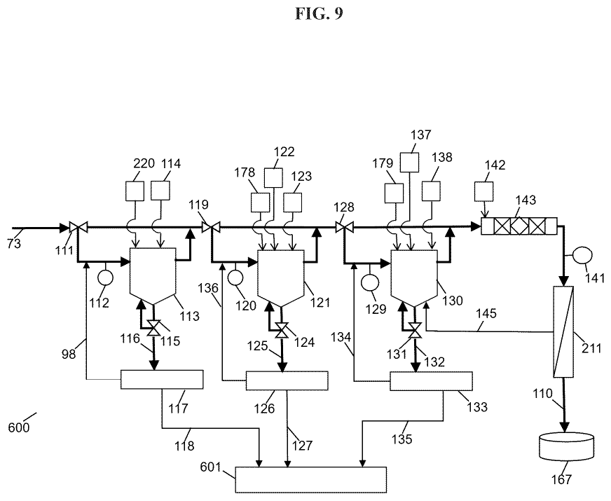

FIG. 9 shows an example of the dissolved solids recovery unit 600 with sequential precipitation and separation of cryolite, Ettringite and Friedel's salt to remove fluoride, sulfate and chloride respectively from retentate 73. The feed retentate 73 is directed by control valve 111 to fluoride solids contact clarifier 113 to remove fluoride by cryolite precipitation or to control valve 119 if fluoride removal is not required.

Before entering the fluoride solids contact clarifier 113, the temperature and pH of the feed retentate 73 is measured by sensors 112. If the pH is outside of range 3-8, the pH in the contact clarifier 113 is adjusted with base or acid 220 to maintain a pH of 6-6.8. If the temperature is greater than 50° C., the temperature is controlled in the contact clarifier to less than 50° C., preferably within a range of 20-30° C.

Sodium aluminate 114 is added with the retentate 73 to the fluoride contact clarifier 113 at a fluoride to aluminum molar ratio of 5-7 where they are mixed. Cryolite is precipitated as a sludge 116 and recycled to improve precipitation. To maintain a steady state, a portion of the cryolite sludge 116 is discharged and directed by control valve 115 to solids dewatering 117 where it is dried. The recovered water 98 from solids dewatering 117 is returned to the feed retentate 73. Dried cryolite 118 is collected and directed to solids handling depot 601 for storage and/or off-take sales. The clarified retentate 73 exits the contact clarifier 113 and is directed to control valve 119.

If the retentate 73 requires sulfate removal, it is directed to the sulfate solids contact clarifier 121 by control valve 119 or it is directed to control valve 128. Before entering the sulfate solids contact clarifier 121, the pH and temperature of the retentate 73 is measured by sensor 120. If the pH is outside of range 11-12, the pH in the contact clarifier 121 is adjusted with base or acid 178 from the cleaning skid 54 to maintain a pH=11.2-11.6. If the temperature is greater than 90° C., the temperature is controlled in the contact clarifier 121 to 20-50° C.

Sodium aluminate 123 and lime 122 are added with the retentate 73 to the sulfate contact clarifier 121 at an aluminum to sulfate molar ratio of 0.75-2, preferably 1-1.25, and a calcium to sulfate molar ratio of 2-4, preferably 3-3.5, where they are mixed. Ettringite is precipitated as a sludge 125 and recycled to improve precipitation. To maintain a steady state, a portion of the Ettringite sludge 125 is discharged and directed by control valve 124 to solids dewatering 126 where it is dried. The recovered water 136 from solids dewatering 126 is returned to the feed retentate 73. The dried Ettringite 127 is collected and directed to solids handling depot 601 for storage and/or off-take sales. The clarified retentate 73 exits the contact clarifier 121 and is directed to control valve 128.

If the retentate 73 requires chloride removal, it is directed to the chloride solids contact clarifier 130 by control valve 128. Before entering the chloride solids contact clarifier 130, the pH and temperature of the retentate 73 is measured by sensor 129. If the pH is outside of range 11-12.5, the pH in the contact clarifier 130 is adjusted with base or acid 179 from the cleaning skid 54 to maintain a pH=12. If the temperature is greater than 65° C., the temperature is controlled in the contact clarifier 130 to maintain a temperature of 25-35° C.

Sodium aluminate 138 and lime 137 are added with the retentate 73 to the chloride contact clarifier 130 at an aluminum to chloride molar ratio of 4 and a calcium to aluminum molar ratio of 2-2.5, where they are mixed. Friedel's salt is precipitated as sludge 132 and recycled to improve precipitation. To maintain a steady state, a portion of Friedel's sludge 132 is discharged and directed by control valve 131 to solids dewatering 133 where it is dried. The recovered water 134 from solids dewatering 133 is returned to the feed retentate 73. Dried Friedel's salt 135 is collected and directed to solids handling depot 601 for storage and/or off-take sales.

Clarified retentate 73 exits the contact clarifier 130 and is directed to residual calcium carbonate and aluminum hydroxide precipitation and removal step. Carbon dioxide gas 142 is injected and mixed into the retentate 73 with an inline static mixer 143 to neutralize the pH. The amount of CO₂ added is automatically controlled by measuring the pH of the retentate 73 after CO₂ mixing by sensor 141. If the pH is greater than 8, carbon dioxide gas is injected to maintain a pH range of 6-8. The resulting precipitated calcium carbonate and aluminum hydroxide particles are removed from the clarified retentate 73 by low pressure filtration, preferably ultrafiltration 211. The filter backwash 145 is returned to the contact clarifier 130. The filtered retentate 110 exits the dissolved solids recovery unit 600 and is directed to the filtration retention tank 167.

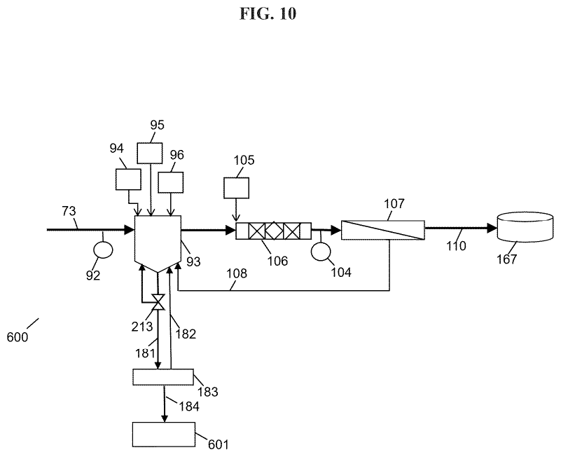

FIG. 10 shows an embodiment of the dissolved solids recovery unit 600 with single step precipitation and separation of Ettringite and Friedel's salt. The feed retentate 73 is directed to solids contact clarifier 93. Before entering the contact clarifier 93, the pH and temperature of the retentate 73 are measured by sensor 92. If the pH is outside of range 11-13, the pH in the contact clarifier 93 is adjusted with base or acid 94 from the cleaning skid 54 to maintain a pH 12-12.5. If the retentate 73 temperature is greater than 65° C., the temperature is controlled in the contact clarifier 93 to maintain a temperature of 25-35° C.

Sodium aluminate 95 and lime 96 are added with the retentate 73 to the contact clarifier 93 at an aluminum to sum of chloride+sulfate molar ratio of 2-4, preferably 1.5-2, and a calcium to aluminum molar ratio of 1-3, preferably 2-2.5, where they are mixed. A mixture of Ettringite and Friedel's salt is precipitated as sludge 181 and recycled to improve precipitation. To maintain a steady state, a portion of sludge 181 is discharged and directed by control valve 213 to solids dewatering unit 183 (not in figure) where it is dried. The recovered water 182 from solids dewatering 183 is returned to the contact clarifier 93 (not in figure [symbol] . Dried Ettringite and Friedel's salt 184 is collected and directed to solids handling depot 601 for storage.

Clarified retentate 73 exits the contact clarifier 93 and is directed to residual calcium carbonate and aluminum hydroxide precipitation and removal step. Carbon dioxide gas 105 is injected and mixed into the retentate 73 with an inline static mixer 106 to neutralize the pH. The amount of CO₂ added is automatically controlled by measuring the pH of the retentate 73 after CO₂ mixing by sensor 104. If the pH is greater than 8, carbon dioxide gas is injected to maintain a pH range of 6-8. The resulting precipitated calcium carbonate and aluminum hydroxide particles are removed from the clarified retentate 73 by low pressure filtration, preferably ultrafiltration 107. The filter backwash 108 is returned to contact clarifier 93. The filtered retentate 110 exits the dissolved solids recovery unit 600 and is directed to the filtration retention tank 167.

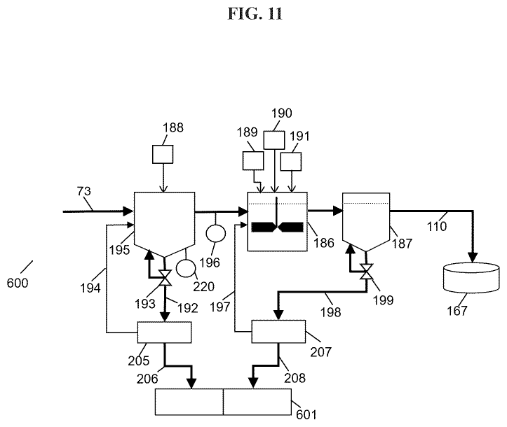

FIG. 11 shows an embodiment of the dissolved solids recovery unit 600 with two step gypsum and Ettringite precipitation and separation. To remove dissolved sulfate from a retentate with sulfate concentration greater than 1500 mg/L to a target sulfate level below 250 mg/L, a gypsum precipitation and separation step may precede the sodium aluminate precipitation and separation step. The dissolved solids recovery unit 600 comprises side-by-side solids contact clarifier 195, mixer 186 and clarifier 187.

Feed retentate 73 is directed into solids contact clarifier 195 where hydrated lime 188 is added to maintain a pH of 10.5-12 to form gypsum. The amount of hydrated lime 188 dosing is controlled by measuring the pH of the liquid in the contact clarifier 195 using pH sensor 220. Gypsum is precipitated as sludge 192 and recycled to improve precipitation. To maintain a steady state, a portion of sludge 192 is discharged and directed by control valve 193 to solids dewatering unit 205 where it is dried. The recovered water 194 from solids dewatering 205 is returned to the contact clarifier 195. Dried gypsum 206 is collected and directed to solids handling depot 601 for storage.

Precipitated sludge 192 settles to the bottom of the contact clarifier 195 and the clarified retentate 73 at the top is directed to a mixer 186 and clarifier 187 to precipitate Ettringite. Before entering mixer 186, the pH and temperature of the retentate 73 is measured by sensor 196. If the pH is outside of range 11-12, the pH in the mixer 186 is adjusted with base or acid 189 from the cleaning skid 54 to maintain a pH=11.2-11.6. If the temperature is greater than 90° C., the temperature is controlled in the mixer 186 to 20-50° C.

Sodium aluminate 190 and hydrated lime 191 are added with the retentate 73 to the mixer 186 at an aluminum to sulfate molar ratio of 0.75-2, preferably 1-1.25, and a calcium to sulfate molar ratio of 2-4, preferably 3-3.5, where they are mixed. Once mixed, retentate 73 is directed to a clarifier where Ettringite is precipitated as a sludge 198 and recycled to improve precipitation. To maintain a steady state, a portion of the Ettringite sludge 198 is discharged and directed by control valve 199 to solids dewatering unit 207 where it is dried. The recovered water 197 from solids dewatering 207 is returned to the clarifier 186. The dried Ettringite 208 is directed to solids handling depot 601 for storage and/or off-take sales. Clarified retentate 110 exits the clarifier 187 the dissolved solids recovery unit 600 and is directed to the filtration retention tank 167.

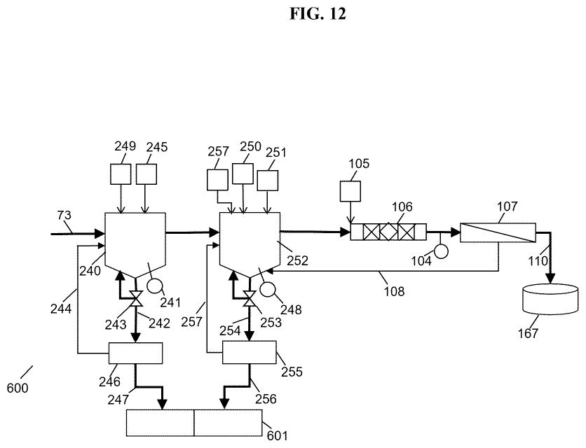

FIG. 12 shows an embodiment of the dissolved solids recovery unit 600 with two stage chemical coagulation, precipitation and separation. Retentate 73 is fed to the solids contact clarifier 240. The pH is measured by pH sensor 241 and the pH is adjusted by acid or base chemicals 249 to maintain a pH=8.5 in the contact clarifier 240. Sodium aluminate 245 is added with the retentate 73 and recycled sludge 242. The amount of sodium aluminate 245 added is dependent upon the concentration of dissolved solids, metals, dissolved organic matter, colloids, silica, phosphorous, and other contaminants and the desired fraction of their removal. The dosing rate is determined from laboratory experimentation and water quality analysis. To maintain a steady state, a portion of sludge 242 is discharged and directed by control valve 243 to solids dewatering unit 246 where it is dried. The recovered water 244 from solids dewatering 246 is returned to the contact clarifier 240. Dried solids 247 are directed to solids handling depot 601 for storage. The clarified retentate 73 leaves contact clarifier 240 and is directed to contact clarifier 252.

Clarified retentate 73 is fed to contact clarifier 252 with pH adjusting chemicals 257, sodium aluminate 250, recycled sludge 254, and/or lime 251. The pH is the contact clarifier 252 is measured by pH sensor 248 and maintained at 11.5 by controlled dosing of chemicals 257. The molar concentrations of aluminum and calcium dosed are dependent on the water concentration of chloride, sulfate, lithium and/or fluoride, and the desired fraction of their removal.

To maintain a steady state, a portion of sludge 254 is discharged and directed by control valve 253 to solids dewatering unit 255 where it is dried. The recovered water 257 from solids dewatering 255 is returned to the contact clarifier 252. Dried solids 256 are directed to solids handling depot 601 for storage. The clarified retentate 73 leaves contact clarifier 252 and is directed to residual calcium carbonate and aluminum hydroxide precipitation and removal step.

Carbon dioxide gas 105 is injected and mixed into the retentate 73 with an inline static mixer 106 to neutralize the pH. The amount of CO₂ added is automatically controlled by measuring the pH of the retentate 73 after CO₂ mixing by sensor 104. If the pH is greater than 8, carbon dioxide gas is injected to maintain a pH range of 6-8. The resulting precipitated calcium carbonate and aluminum hydroxide particles are removed from the clarified retentate 73 by low pressure filtration, preferably ultrafiltration 107. The filter backwash 108 is returned to contact clarifier 252. The filtered retentate 110 exits the dissolved solids recovery unit 600 and is directed to the filtration retention tank 167.

While multiple embodiments are disclosed, still other embodiments of the disclosure will become apparent to those skilled in the art from the following detailed description, which shows and describes illustrative embodiments of the disclosed apparatus, systems, and methods. As will be realized, the disclosed apparatus, systems and methods are capable of modification in various obvious aspects, all without departing from the spirit and scope of the disclosure.

While the above disclosure has been specfically described, along with specific embodiments, one skilled in the art would understand that many alternatives, modifications and variations are apparent in light of the above description. It is therefore contemplated that the appended claims may include any such alternatives, modifications and variations as falling within the full scope and spirit of the disclosure herein.

1. A water purification system comprising:
a water retentate treatment module comprising an electrolytic treatment unit and a dissolved solids recovery unit,
wherein a water retentate stream is received in a electrolytic treatment unit which performs at least one process selected from the group consisting of electrochemical oxidation, hardness removal and reduction, and/or
wherein a water retentate stream is received in a dissolved solids removal unit wherein at least one of hydrogen, ammonia, or hydrogen peroxide are recovered.

2. The water purification system of claim 1 wherein the water retentate stream is converted to a electrolytically treated retentate stream in the electrolytic treatment unit and the electrolytically treated retentate stream is transferred to the dissolved solids removal unit from the electrolytic treatment unit.

3. The water purification system of claim 1 additionally comprising:
a preliminary treatment module which receives a contaminated water feed, and removes suspended solids and precipitates from the contaminated water feed to form a treated water feed which is feed to the water retentate treatment module or to a filtration module which receives and filters the treated water feed and forms a permeate water stream and a water retentate stream wherein the water retentate is supplied to the water retentate treatment module.

4. The water purification system of claim 3 wherein the preliminary treatment module comprises
a chemical precipitation unit,
a total suspended solids sensor, and
a solids recovery unit.

5. The water purification system of claim 3 wherein the chemical precipitation unit comprises:
an oxidation vessel,
an ultraviolet light chamber,
a coagulation chamber, and
a vessel including an ultrafiltration cassette.

6. The water purification system of claim 3 additionally comprising:
a solids recovery unit which receives the suspended solids and precipitates removed in the preliminary treatment module and dewaters the suspended solids and precipitates to form recovered water which is returned to the preliminary treatment module.

7. The water purification system of claim 3 wherein the filtration module is included in the water purification system,
wherein the filtration module receives a clarified retentate stream and recovered water from the dissolved solids recovery unit, and produces a permeate stream.

8. The water purification system of claim 7 additionally comprising
a disinfection module which receives the permeate stream from the filtration module and produces purified water.

9. The water purification system of claim 8 wherein the disinfection module comprises:
at least one inline static mixer,
a UV chamber suitable for preforming a UV treatment step,
an inline mixer, and
a mineral filter.

10. The water purification system of claim 1 wherein additionally comprising:
a recovery and storage unit which receives least one of hydrogen, ammonia, or hydrogen peroxide which are recovered from the electrolytic treatment unit.

11. The water purification system of claim 1 additionally comprising:
a solids handling depot which receives dry precipitates from the dissolved solids recovery unit.

12. A water retentate treatment module comprising:
an electrolytic treatment unit and a dissolved solids recovery unit,
wherein the electrolytic treatment unit comprises:
at least one electrolytic oxidation-softening stack,
at least one electrolytic oxidation stack, and
at least one electrolytic reduction stacks; and
wherein the dissolved solids recovery unit comprises:
a lime or lime-soda ash softening unit,
a second step is cryolite precipitation unit,
a Ettringite precipitation unit,
a Friedel's salt precipitation unit, and
a filtration unit.

13. The water retentate treatment module of claim 12 additionally comprising a recovery and storage unit in fluid connection with the oxidation-softening stack.

14. The water retentate treatment module of claim 12 additionally comprising a preliminary treatment module in fluid connection with the electrolytic treatment unit.

15. The water retentate treatment module of claim 14 wherein the preliminary treatment module comprises:
an oxidation vessel,
a coagulation chamber, and
a vessel including an ultrafiltration cassette.

16. The water retentate treatment module of claim 14 wherein the preliminary treatment module additionally comprises an ultraviolet light chamber.

17. The water retentate treatment module of claim 12 additionally comprising a solids handling depot in fluid connection with the dissolved solids recovery unit.

18. A water treatment method comprising:
receiving a retentate feed water stream into a electrolytic treatment unit,
electrolytically treating the retentate feed water stream in the electrolytic treatment unit to provide an electrolytically treated retentate,
receiving the electrolytically treated retentate in a dissolved solids recovery unit,
filtering the electrolytically treated retentate in the dissolved solids recovery unit to provide a clarified retentate stream and a stream comprising precipitated dissolved solids and dry precipitates.

19. The water treatment method of claim 18 wherein electrolytically treating the retentate feed water stream in the electrolytic treatment unit comprises at least one process selected from the group consisting of electrochemical oxidation, hardness removal and reduction, and
wherein filtering in the dissolved solids recovery unit comprises at least one process selected from the group consisting of a lime or lime-soda ash softening step, a cryolite precipitation step, an ettringite precipitation step, and a friedel's salt precipitation step,
wherein at least one of hydrogen, ammonia, or hydrogen peroxide are recovered.

20. The water treatment method of claim 18 additionally comprising:
pretreating a contaminated water to form a retentate feed water stream wherein pretreating comprises at least one process selected from the group consisting of a chemical oxidation step, exposure to ultraviolet light within an ultraviolet light chamber, injection of a coagulant and mixing within a coagulation chamber, and flocculation and settling in a vessel including an ultrafiltration cassette.
